(19) United States
(12) Patent Application Publication
(10) Pub. No.: US 2023/0042992 A1
(43) Pub. Date: Feb. 9, 2023

(54) DISBURSEMENT AUTHORIZATION DATA OBJECT PROCESSING SYSTEM UTILIZING REAL-TIME STATUS DATA AND AUTHENTICATION KEYS

(71) Applicant: Assurant, Inc., New York, NY (US)

(72) Inventors: Andy Loveland, Atlanta, GA (US); Lisa Murphy, Florence, SC (US); George Greenman, Acworth, GA (US)

(21) Appl. No.: 17/443,062

(22) Filed: Jul. 20, 2021

(51) Int. Cl. G06Q 40/00; G06Q 20/40; G06Q 20/10; G06Q 20/38

(52) U.S. Cl. CPC G06Q 40/125; G06Q 20/405; G06Q 20/108; G06Q 20/3829

(57) ABSTRACT

A disbursement authorization data object processing system receives disbursement authorization data objects from a plurality of client devices. A real-time status reporting service is invoked to determine real-time status report data associated with the disbursement authorization data object. Using the real-time status report data, the disbursement authorization data object processing system invokes a disbursement authorization service to determine recipient instruction data which may include a recipient instructions status code. An disbursement instruction data object may then be transmitted to the client device that transmitted the disbursement authorization data object. The client device may facilitate the submission of additional documentation, selection of certain recipient instruction data, and/or the like to transmit to the disbursement authorization data object processing system in associated with a disbursement authorization data object.

### TECHNOLOGICAL FIELD

Various embodiments relate generally to a disbursement authorization data object processing system and management, creation, transmission, and processing of disbursement authorization data objects.

### BACKGROUND

Current disbursement authorizations systems have disadvantages, particularly if processing operations involve extracting, compiling, and harmonizing real-time data sets in a low latency and secure network environment. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

A disbursement authorization data object processing system is provided, that is configured to process disbursement authorization data objects received from a plurality of client devices in a network. The disbursement authorization data object processing system includes one or more computers and one or more storage devices storing instructions that are operable, when executed by the one or more computers, to cause the disbursement authorization data object processing system to monitor the network to identify a received disbursement authorization data object.

The disbursement authorization data object processing system is further configured to parse the disbursement authorization data object to obtain disbursement authorization parameters and associate the disbursement authorization parameters with at least a first recipient entity and at least one external entity based on the disbursement authorization parameters.

In response to parsing the disbursement authorization data object, the disbursement authorization data object processing system invokes a real-time status reporting service to retrieve at least one real-time status report data object associated with the disbursement authorization parameters and comprising real-time status report data.

In response to retrieving the real-time status report data object, the disbursement authorization data object processing system, using at least the real-time status report data object and the disbursement authorization parameters, invokes a disbursement authorization service to determine recipient instruction data. The disbursement authorization data object processing system further generates a disbursement instruction data object comprising at least the recipient instruction data, and causes transmission of the disbursement instruction data object to a client device from which the disbursement authorization data object was received.

According to certain embodiments, determining the recipient instruction data comprises determining whether two or more external entities are identified as potential additional recipient entities, wherein the instructions are further operable to cause the disbursement authorization data object processing system to generate a unique authentication key, and store the unique authentication key in association with the disbursement authorization parameters. The instructions may be further operable to cause the disbursement authorization data object processing system to populate the disbursement instruction data object with the unique authentication key prior to the transmission of the disbursement authorization data object to the client device from which the disbursement authorization data object was received.

According to certain embodiments, the instructions are further operable to cause the disbursement authorization data object processing system to receive a resubmission disbursement authorization data object comprising at least the unique authentication key and a selected one of the two or more external entities identified as potential additional recipient entities, and populate the disbursement authorization parameters associated with the unique authentication key with the selected one of the two or more external entities identifies as potential additional recipient entities. In this regard, invoking the disbursement authorization service comprises utilizing the disbursement authorization parameters populated with the selected one of the two or more external entities.

The instructions may be further operable to cause the disbursement authorization data object processing system to determine whether additional documentation is required, and populate the disbursement instruction data object with an additional documentation required indicator prior to the transmission of the disbursement instruction data object to the client device from which the disbursement authorization data object was received.

According to certain embodiments, the disbursement instruction data object comprises a unique authentication key, and the instructions are further operable to cause the disbursement authorization data object processing system to receive an additional documentation data object comprising at least the unique authentication key and a document, and parse the document and update at least one of the disbursement authorization parameters associated with the authentication key with adjustment data parsed from the document. Invoking the disbursement authorization service may include utilizing the updated disbursement authorization parameters comprising the adjustment data.

The disbursement authorization parameters may include at least two entities, and invoking the disbursement authorization service may result in determining at least one of the two entities is not required as an additional recipient entity of an associated disbursement.

According to certain embodiments, invoking the disbursement authorization service comprises utilizing the disbursement authorization parameters and the real-time status report data to process at least one external entity rule set associated with the disbursement authorization parameters.

According to certain embodiments, if any rules indicate at least one external entity is required, the disbursement authorization data object processing system populates the disbursement instruction data object with an indication that the external entity is required as the additional recipient entity.

In some circumstances, the real-time status report data object comprises a delinquency indicator, and invoking the disbursement authorization service results in the recipient instruction data indicating the at least one external entity is required as the additional recipient entity.

A computer-implemented method is also provided for processing disbursement authorization data objects received from a plurality of client devices in a network. The computer-implemented method may include monitoring the network to identify a received disbursement authorization data object, and parsing the disbursement authorization data object to obtain disbursement authorization parameters and associate the disbursement authorization parameters with at least a first recipient entity and at least one external entity based on the disbursement authorization parameters.

The computer-implement method may further include, in response to parsing the disbursement authorization data object, invoking a real-time status reporting service to retrieve at least one real-time status report data object associated with the disbursement authorization parameters and comprising real-time status report data.

In response to retrieving the real-time status report data object, the computer-implemented method may include, using at least the real-time status report data object and the disbursement authorization parameters, invoking a disbursement authorization service of the disbursement authorization data object processing system to determine recipient instruction data. The computer-implemented method may include generating a disbursement instruction data object comprising at least the recipient instruction data, and causing transmission of the disbursement instruction data object to a client device from which the disbursement authorization data object was received.

A computer program product is also provided, for processing disbursement authorization data objects received from a plurality of client devices in a network, the computer program product comprising at least one non-transitory computer-readable storage medium having computer-executable program code instructions stored therein, the computer-executable program code instructions comprising program code instructions to monitor the network to identify a received disbursement authorization data object, and parse the disbursement authorization data object to obtain disbursement authorization parameters and associate the disbursement authorization parameters with at least a first recipient entity and at least one external entity based on the disbursement authorization parameters.

The computer-executable program code instructions further include program code instructions to, in response to parsing the disbursement authorization data object, invoke a real-time status reporting service to retrieve at least one real-time status report data object associated with the disbursement authorization parameters and comprising real-time status report data.

The computer-executable program code instructions further include, in response to retrieving the real-time status report data object, and using at least the real-time status report data object and the disbursement authorization parameters, invoking a disbursement authorization service of the disbursement authorization data object processing system to determine recipient instruction data. The computer-executable program code instructions further include program code instructions to generate a disbursement instruction data object comprising at least the recipient instruction data, and cause transmission of the disbursement instruction data object to a client device from which the disbursement authorization data object was received.

### BRIEF DESCRIPTION OF THE SEVERAL VIEWS OF THE DRAWINGS

Reference will now be made to the accompanying drawings, which are not necessarily drawn to scale, and wherein:

FIG. 1 shows a schematic view of a computing environment in which various embodiments of the present disclosure may operate;

FIG. 2 shows a schematic view of a disbursement authorization apparatus configured according to one embodiment;

FIGS. 3A-3D are flowcharts illustrating operations in accordance with various embodiments of the present disclosure; and

FIGS. 4A-4G are example user interface displays of a development and testing tool in accordance with various embodiments of the present disclosure.

### DETAILED DESCRIPTION

The present disclosure describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Overview

Disbursement authorization data object processing systems are configured to facilitate the processing of disbursement authorization data objects based on data sets, rules, and algorithms drawn from various sources, including external sources, in real-time low latency operations. The disbursement authorization data objects are transmitted over a network from various client devices, such as carrier systems configured to interface with the disbursement authorization data object processing system, user devices running mobile software applications and/or the like In some instances such user applications may be hosted by the disbursement authorization data object processing system and/or carrier system.

In one embodiment, a disbursement authorization data object processing system may be managed by a service provider to insurance carrier and configured to manage data associated with property claims to be paid to member users. Efficient management of property claims data can offer a variety of technical challenges. Each property claim embodied by the property claims data is associated with a disbursement authorization data object. The disbursement authorization data object processing system tracks mortgagee clauses for one or more lenders associated with a property insurance policy, such that any disbursement to the property owners made based on such property claims data may include multiple payees. The disbursement authorization data object processing system generates disbursement instruction data objects to indicate payee(s). The multiple payees may include the property owners, and any number of additional recipient entities, such as external entities supported by disparate networks and servers, such as lenders, lienholders and/or mortgagees.

In circumstances where a disbursement associated with a property claim is determined to require multiple payees, the disbursement authorization data object processing system must be configured to facilitate multiple payee endorsement operations. Otherwise, property owners or other payees will be prohibited from depositing the disbursement.

In some instances, such as but not limited to when significant damage occurs to the property and the mortgagee(s) needs to ensure adequate repairs are completed with the funds, or when a total loss warrants a principal payment, dual endorsement may be required to protect a lender. However, in some instances, such as but not limited to claims involving minor damage to a property, the mortgagee(s) may devise rule sets that when applied determine that a dual endorsement is not required or may be waived.

Determining whether a mortgagee(s) should be included as an additional recipient entity on a disbursement introduces many technical challenges. Various external entities, such as lenders, may have different rule sets, validation and authentication operations, and/or thresholds for determining when claims require dual endorsement or determining when dual endorsement can be waived, and such rules are provided by various networks or platforms operated by different financial institutions and/or their respective service providers. In some instances, different rules may govern regulation in different jurisdictions such that an owner of the rules sets needs to ensure compliance with the programmed rule sets.

Additional technical challenges include that a determination regarding dual endorsement in each particular scenario is dependent on a real-time status data maintained in association with a borrower's (e.g., property owner's) mortgage account. For example, a property owner who is delinquent on their mortgage, property taxes, insurance premiums, and/or the like, may be determined to be subject to a dual endorsement requirement on paid claims. Such statuses should be assessed in real-time or near real-time as a payment is disbursed to protect the interest of the mortgagee(s). Different financial institutions may utilize different services and/or utilize different interfaces to store and secure such real-time status data, which may be inaccessible or unreadable by typical insurance carrier systems. Additionally, the data returned by such financial institutions and/or respective service providers may be in different formats, which are not necessarily standardized across the lending industry, and are not necessarily compatible with the disbursement authorization data object processing system and/or carrier system in the formats respectively returned.

Additional technical complexities are introduced in scenarios in which not all data is available that is needed to determine a dual endorsement requirement or dual endorsement waiver. In some instances, an additional documentation data object is provided in association with a claim, and such information may not be immediately available upon initial receipt of a disbursement request or property claim. If such information is needed, the disbursement authorization data object processing system according to certain embodiments provided herein may monitor a network for additional documentation data objects provided by a client device, such as one used by an adjuster to provide the additional documentation. The disbursement authorization data object processing system may need to again obtain a real-time or near real-time status data to process along with the additional documentation data object, to effectively generate the disbursement instruction data object, and indicate whether dual endorsement may be required or whether the insurance carrier can opt-out of requiring dual endorsement (e.g., waive dual endorsement).

Still further, various insurance carriers may have different requirements, rules, algorithms, and/or thresholds for determining whether dual endorsement is required. Different geographic or political jurisdictions may have varying regulations for how dual endorsement is enforced or waived. For example, some jurisdictions may prohibit a requirement for dual endorsement in certain scenarios to protect the insured party. Other regulations may be enforced and may change on an ongoing basis and may vary amongst jurisdictions. Accordingly, to effectively implement systematic dual endorsement requirements or waivers, the disbursement authorization data object processing system according to certain example embodiments provided herein, harmonizes the data and enforces rules set forth by disparate systems, including but not limited to real-time status reporting systems.

Additional strain and complexities are placed on the disbursement authorization data object processing system and/or associated systems to validate payments requiring dual endorsement, such as at the time of deposit by the property owner. Such payments having multiple payees require dual validation of signatures, and with the increase of mobile deposits, and/or other electronic banking means, the complexities of such dual validation further increase, requiring increased utilization of network, processing, and memory resources. Dual validation systems are described in further detail in U.S. application Ser. No. 17/172,784, filed Feb. 10, 2021, and entitled, “System and Methods for Remotely Generating, Authenticating, and Validating Dual Validation Data Objects,” the entire contents of which is hereby incorporated in its entirety. Given that multiple (e.g., hundreds or thousands) disbursements may be issued daily, certain embodiments herein provide an efficient means of reducing the number of payments requiring a dual endorsement, and therefore reduce the consumption of network, processing and/or memory resources for a multitude of systems. For example, the disbursement authorization data object processing system is improved according to certain embodiments provided herein, by reducing the number of dual endorsement data objects representing deposits for which validation of dual endorsement is required, and therefore reducing the utilization of computational resources associated therewith. The strain on external systems to process the payee line of a payment and correctly invoke a dual validation service may be reduced, thereby further reducing the consumption of its respective processing, memory, and network resources to process, forward, and reconcile transactions requiring dual endorsement. Similarly, the strain on a dual validation system to process such dual validation data objects is further reduced according to example embodiments provided herein. The carrier system may also be improved by reducing or eliminating the need for system-assisted manual review of disbursement transactions in which an insurance representative may otherwise add or remove a lender to modify the payee of a disbursement. A system-assisted manual review requires a multitude of additional data objects to track and route validation processes, obtain approvals, confirmations of remitted funds, requests for further validation, and/or the like, and therefore consumes processing and memory resources that could be utilized by other processes of associated systems. Accordingly, the reduction or elimination of system-assisted manual review according to example embodiments further reduces the computer and network resources required to track system-assisted manual review, corresponding user inputs, and updates to corresponding transaction data.

### Definitions

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the term “user” should be understood to refer to an individual or entity. The users referred to herein are enabled to access functionalities associated with a disbursement authorization data object processing system and/or carrier system using user devices. Each user may be associated with at least one user identifier.

The term “recipient entity” refers to a unique data structure identifiable by the disbursement authorization data object processing system as associated with a payee of a disbursement. A recipient entity may be associated with a property owner (e.g., borrower), and/or an external entity such as a lender (e.g., mortgagee).

The term “external entity” refers to a unique data structure identifiable by the disbursement authorization data object processing system as associated with an entity, such as but not limited to a lender, financial institution, and/or mortgagee, that may be identified as an additional recipient entity, or additional payee (additional to an entity that is the insured party, borrower, and/or property owner), of a disbursement. In this regard, the external entity may exclude the insured party, borrower and/or property owner. The external entity, by its structured data that may include an address or locator of a resource on a network, is associated with a real-time status reporting system and service, described in further detail below.

The term “additional recipient entity parameter” is a data structure determined by the disbursement authorization data object processing system that may be populated or updated as the disbursement authorization data object processing system processes disbursement authorization data object against rules. The additional recipient entity parameter may indicate whether or not an external entity should be included as an additional recipient of a disbursement. The additional recipient entity parameter may be a Boolean value, and in instances in which the value is set to true, the additional instruction data object indicates the external entity should be included on a disbursement, and in instances in which the value is set to false, the additional instruction data object indicates the external entity need not be included on a disbursement. However, according to some embodiments, the aforementioned usage of the Boolean values may be reversed. Still further, the additional recipient entity parameter may be implemented as a quantifiable parameter according to certain embodiments, such that the invocation of the disbursement authorization service generates and/or modifies the additional recipient entity parameter and the value of the additional recipient entity parameter in comparison to a predefined threshold value determines the additional instruction data. When all required disbursement authorization parameters are processed against all applicable rules, the value of the additional recipient entity parameter may indicate a recipient instruction data and/or the like.

As used herein, the term “user identifier” refers to one or more items of data by which a particular user associated with the user may be uniquely identified. For example, in one embodiment, a user identifier may be stored as an unsigned integer and represented externally (outside of memory) as a base-34 encoded string. In other embodiments, the client identifier may comprise a combination of American Standard Code For Information Interchange (ASCII) characters.

The term “user device” refers to computer hardware and/or software that is configured to access a service made available by a server, optionally via a client device and/or carrier system. User devices may include, without limitation, smart phones, tablet computers, laptop computers, personal computers, enterprise computers, and the like. User devices, as described herein, communicate with and otherwise access systems such as a carrier system via one or more networks. A user device associated with a carrier system may be utilized to receive claim data, process the data, and forward requests to the disbursement authorization data object processing system.

The user device sometimes communicates indirectly with a disbursement authorization data object processing system by way of a client device, which may apart of the carrier system and/or communicatively connected thereto. The “client device” may be any computer hardware and/or software that is configured to access a service made available by a server. According to certain embodiments, such as when software associated with the carrier system is operative on a user device, the client device and user device may be one in the same, such that the user device communicates with a remote server such as that of the disbursement authorization data object processing system.

A client device may be uniquely identified by a client device identifier. The “client device identifier” refers to one or more items of data by which a particular client device, such as one associated with a carrier systems, may be uniquely identified. For example, in one embodiment, a client device identifier may be an address or locator of the client device on a network. The client device identifier associated with a carrier system making a request, such as with a disbursement authorization data object, may be stored in the disbursement authorization data object processing system to route responses, which may be in the form of recipient instruction data objects, to the client device from which a request was received.

The term “carrier system” refers to a server and/or distributed computing system configured to host one or more applications and supporting software and/or hardware, and may operate as compiled code bases or repositories that are separate and distinct from those that support the disbursement authorization data object processing system and/or remote-status reporting system. Numerous carrier systems operate behind respective firewalls, security frameworks, and communication protocols that govern communication with any other network service or apparatus. The carrier system may be associated with an insurance carrier that provides insurance coverage to property owners and may further fund disbursements to homeowners in the event of a loss claim. The carrier system may configured to host a multitude of insurance carrier services, including but not limited to facilitating the processing of loss claims from property owners, and transmitting associated disbursement authorization data objects to the disbursement authorization data object processing system. The applications and software of different carrier systems may provide respective user interfaces to their internal users (e.g., an insurance representative) and external users (e.g. an insured party) to facilitate the collection of data, population of the disbursement authorization data objects, and transmission of disbursement authorization data objects, such as with a client device that invokes an application programing interface (API) of the disbursement authorization data object processing system.

The term “disbursement authorization data object processing system” refers to a software and hardware system that is configured to support disbursement authorization and authentication processes associated with disbursement authorization data objects. For example, a disbursement authorization data object processing system is configured to receive inputs such as disbursement authorization data objects from client devices on behalf of a carrier system, and processes these inputs accordingly to generate a disbursement instruction data object. Such disbursement instruction data objects may be configured to initiate disbursements according to instructions contained therein. Disbursement authorization data object processing systems may be configured to communicate with various devices and services through a disbursement authorization application programming interface (API).

The term “data object” refers to a structured arrangement of data. A “disbursement authorization data object” is a structured set of data and instructions issued by a specifically configured software application or “app” running on a client device, such as associated with a carrier system, to a disbursement authorization data object processing system. The disbursement authorization data object includes one or more “disbursement authorization parameters” associated with a claim transmitted by a user associated with a particular insurance policy, covered asset, and loan account, and forwarded to the disbursement authorization data object processing system by a client device associated with a carrier system. A disbursement authorization data object is received by the disbursement authorization data object processing system and is parsed and processed to determine a disbursement instruction data object (and/or disbursement instruction data object) to return to the carrier system, as described in further detail herein. Receipt of a disbursement authorization data object may trigger, as a part of the determination of the disbursement instruction data object, invocation of a real-time status reporting service to retrieve a real-time status report data object from a real-time status reporting system.

A “real-time status reporting system” is an external system associated with an external entity, and may include a server and/or distributed computing system configured by software programs and applications to host a multitude of services and functionality. The external entity is associated with, sometimes via a one-to-one relationship, with a real-time status reporting system. However, in some embodiments, a real-time status reporting system may serve multiple external entities, or according to some embodiments or instances, multiple real-time status reporting systems may serve a single external entity. In some embodiments, a disbursement authorization data object processing system accesses the real-time status reporting system via a real-time status reporting service. The real-time status reporting system may comprise a multitude of compiled code bases or repositories that are separate and distinct from that which supports the disbursement authorization data object processing system and/or carrier system. The real-time status reporting system operates behind firewalls, security frameworks, and communication protocols that govern communication with any other network service or apparatus. The real-time status reporting system may be a financial institution system or other system associated therewith, and may perform a variety of services for the external entity and/or financial institution.

The “real-time status reporting service” may refer to any service, communication interface, and/or the like facilitated by at least a real-time status reporting system, to provide a real-time status report data object to the disbursement authorization data object processing system. The “real-time status report data object” may refer to a set of structured data obtained from the secure and remote real-time status reporting system. The real-time status report data object may include data regarding the status of a loan, such as but not limited to a loan balance, delinquency indicators, days delinquent, property tax delinquency indicator, cost to rebuild, current property value, property tax amount, and/or the like. The real-time status report data object may be received and processed by a disbursement authorization service of the disbursement authorization data object processing system, along with the associated disbursement authorization data object, to generate or update the disbursement instruction data object to return to the carrier system and/or client device associated therewith.

The term “disbursement authorization service” may refer to computer program code operative on the disbursement authorization data object processing system for processing the disbursement authorization data object and real-time status report data with various rules accessible by and/or maintained by the disbursement authorization data object processing system, to generate or update the disbursement instruction data object.

The term “client rule set” may refer to a set of computer program code and optional parameters including but not limited to thresholds, that define rules for a particular carrier system with regards to dual endorsement. In certain embodiments, the client rule set may be optional, but at least an external entity rule set governs the disbursement instructions determined by the disbursement authorization service. The “external entity rule set” refers to a set of computer program code and optional parameters including but not limited to thresholds that define rules for a particular real-time status reporting system and/or associated external entity.

The term “disbursement instruction data object” refers to an instruction, command, or signal that is output by a disbursement authentication system to a client device of the carrier system, and/or a user device in communication therewith, that may be configured to confirm or initiate issuance of a disbursement instrument (e.g., a physical check and/or the like), indicate a request additional information or confirmation and/or selection of certain disbursement authorization parameters, and/or the like.

According to certain embodiments, the disbursement instruction data object may be a structured set of data determined by the disbursement authorization data object processing system and interpretable by a carrier system, and may include any information associated with a respective disbursement authorization data object. The disbursement instruction data object may further include “recipient instruction data,” which may include data determined by the disbursement authorization data object processing system and interpretable by the carrier system for disbursing a payment. The recipient instruction data may be in the format of a string reflecting the payee(s) to be included on a payment, such as the first recipient entity and/or external entity (e.g., mortgagee clause), and/or a message directing a system or user of the entities to be included as payees. Additionally or alternatively, the recipient instruction data may include a disbursement instruction status code, decipherable by the disbursement authorization data object processing system and carrier system (e.g., client device), and indicating the inclusion or optional exclusion of an external entity or entities on a disbursement, or other related status. Example disbursement instruction status codes included in the recipient instruction data are provided in Table 2 and are described in more detail below.

In some embodiments, the disbursement instruction data object may be a renderable disbursement instruction data object configured to enable output via a user interface, and may include recipient instruction data indicating whether at least one external entity is required as an additional recipient entity of an associated disbursement based on the disbursement authorization parameters. According to certain embodiments, the disbursement instruction data object may include an indication that additional documentation is needed prior to disbursing payment, and be further processed by a client device of the carrier system to initiate a request for additional documentation, such as that provided by an adjuster. When the adjuster provides the additional documentation via a user interface of carrier system and/or disbursement authorization data object processing system, an additional documentation data object is returned to the disbursement authorization data object processing system.

An “additional documentation data object” refers to a set of data including information entered by an insurance adjuster to facilitate the processing of and payment of a claim. The additional documentation data object includes a unique authentication key and may further includes a document such as one uploaded by an insurance adjuster. In response to receipt of the additional documentation data object, the disbursement authorization data object processing system matches the unique authentication key to disbursement authorization data parameters, and performs further processing to determine the disbursement instruction data object as described in further detail herein.

The term “unique authentication key” refers to one or more items of data by which a disbursement instruction data object may be uniquely identified. In some embodiments, a unique authentication key may be included in a disbursement instruction data object such that the carrier system can include the unique authentication key with subsequent communications and/or data objects regarding the associated claim. For example, a unique authentication key may comprise ASCII text, a pointer, a memory address, and the like. The unique authentication key may be considered a resubmission key included in an additional documentation data object and/or a resubmission disbursement authorization data object.

The term “resubmission disbursement authorization data object” refers to a set of data including information and instructions issued by a specifically configured software application or “app” running on a client device, such as associated with a carrier system, to a disbursement authorization data object processing system, and is associated with a previously transmitted disbursement authorization data object by the unique authentication key. The resubmission disbursement authorization data object may include new data or corrected data relative to the previously transmitted disbursement authorization data object. For example, the resubmission disbursement authorization data object may indicate a selection of, via a client device of the carrier system, an external entity to be included as an additional recipient entity or payee of the disbursement.

A “resubmission disbursement instruction data object” may be considered an abbreviated version of the disbursement instruction data object provided in response to the resubmission disbursement authorization data object and may include only a subset of the data included in the disbursement instruction data object.

Similarly, a “post-adjustment disbursement instruction data object” may be considered an abbreviated version of the disbursement instruction data object provided in response to the additional documentation data object and may include only a subset of the data included in the disbursement instruction data object.

The term “payment notification data object” refers to a set of data including information and instructions issued by a specifically configured software application or “app” running on a client device, providing details regarding a confirmed disbursed payment. A payment notification data object may be transmitted from the client device to the disbursement authorization data object processing system. In response, records may be updated with data contained therein, and a response object, “payment response data object” may be returned to the client device.

The term “void payment data object” refers to a set of data including information and instructions issued by a specifically configured software application running on a client device, and includes information that a payment is being voided or cancelled. A void payment data object may be transmitted from the client device to the disbursement authorization data object processing system. In response, records may be updated with data contained therein, and a response object, “void payment response data object” may be returned to the client device.

The term “metadata request” may be considered any request, such as one transmitted via a uniform resource locator (URL), from a client system to the distribution authorization system, including a request for statuses and/or metadata. In response thereto, the distribution authorization system may send a “metadata response data object” which is a set of data indicating a status and/or metadata relating to the distribution authorization system.

### Example System Overview

Systems and methods of the present disclosure may be embodied by any of a variety of devices. For example, the systems and methods of an example embodiment may be embodied by a networked computing device (e.g., an enterprise platform), such as a server or other network entity, configured to communicate with one or more devices, such as one or more client devices, one or more user devices, and one or more external services. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

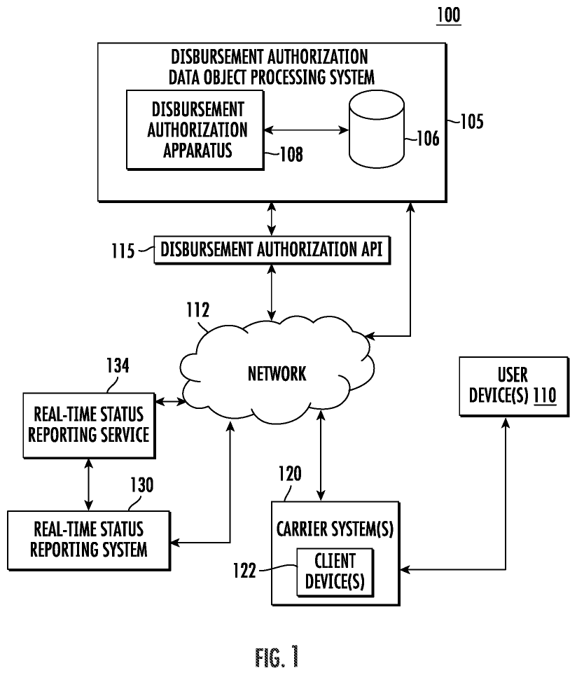

FIG. 1 illustrates an example computing environment 100 within which embodiments of the present disclosure may operate. Users may communicate with a disbursement authorization data object processing system 105 via a network 112 using optional user devices 110. The disbursement authorization data object processing system 105 may comprise a disbursement authorization apparatus 108 in communication with at least one repository 106.

Network 112 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, network 112 may include a cellular telephone, an 802.11, 802.16, 802.20, and/or WiMax network. Further, the network 112 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the disbursement authorization data object processing system 105.

The disbursement authorization apparatus 108 may be embodied as a computer or computers. The disbursement authorization apparatus 108 may provide for receiving of electronic data from various sources, including but not limited to user devices 110 and/or client devices 122. For example, the disbursement authorization apparatus 108 may be operable to receive disbursement authorization data objects from various components and systems in the computing environment 100.

The repository 106 may be embodied as a data storage device such as a Network Attached Storage (NAS) device or devices, or as a separate database server or servers. The repository 106 includes information accessed and stored by the disbursement authorization data object processing system 105 to facilitate the operations of the disbursement authorization data object processing system 105. For example, the repository 106 may store, without limitation, data such as disbursement authorization data objects, disbursement instruction data objects, resubmission disbursement authorization data objects, additional documentation data objects, real-time status report data object, data associated with any of the aforementioned objects, and/or other data to facilitate the operations of the disbursement authorization data object processing system 105.

The repository 106 may further store a plurality of rule sets such as but not limited to external entity rule sets associated with respective financial institutions. A rule set may programmatically define requirements relating to dual endorsement enforcement or waivers, where enforcement indicates two or more recipient entities should be payees on a disbursement (e.g., a first recipient entity that may be the insured party and/or borrower on a loan, in addition to an external entity such as a lender). A dual endorsement waiver may indicate that the insurance carrier may direct payment to the first recipient entity only, and that the lender need not be a payee of the distribution. The rules may be updated on a routine and/or ad-hoc basis such as under the direction of an associated financial institution and/or under direction of a compliance team to ensure enforcement of various jurisdictional regulations. The maintenance of such rules may occur as a separate process from the processes described herein relating to disbursement authorization.

The user devices 110 may be any computing device as defined above. Electronic data that is received by the disbursement authorization data object processing system 105 from the user devices 110 (such as that of an internal insurance associate and/or insured party) may be provided in various formats and via various methods. For example, the user devices 110 may include desktop computers, laptop computers, smartphones, netbooks, tablet computers, and the like.

Additionally, or alternatively, in some embodiments, the disbursement authorization data object processing system 105 may be configured, via software, hardware, or a combination thereof, to perform one or more of the operations disclosed herein with respect to managing disbursement authorization data objects, and/or the like. For example, the disbursement authorization data object processing system 105 may be configured with one or more disbursement authorization application programming interfaces (APIs) 115 accessible to user devices 110, client devices 122, and/or other external sources.

In embodiments where a user device (e.g., a user device 110) is a mobile device, such as a smartphone, laptop, tablet, or the like, the client device may execute an application, or “app,” to interact with the disbursement authorization data object processing system 105. Such apps are typically designed to execute on mobile devices, such as tablets or smartphones. For example, an app may be provided that executes on mobile device operating systems such as iOS®, Android®, Windows® or the like. These platforms typically provide frameworks that allow apps to communicate with one another and with particular hardware and software components of user devices. Additionally, or alternatively, user devices 110 may interact with the disbursement authorization data object processing system 105 via a web browser. As yet another example, client devices 122 may include various hardware or firmware designed to interface with the disbursement authorization data object processing system 105. According to example embodiments, the disbursement authorization data object processing system 105 may be communicatively connected to a carrier system(s) 120, such as those associated with insurance carriers.

A carrier system 120 may function to provide various claims processing services to service insured parties. For example, the carrier system 120 may provide a user interface accessible by insured parties via a user device 110, for submission of claims relating to property loss and/or damage, access to policy information, access to claim statuses, updating claims, and/or the like. Internal users of the carrier system 120 may access user interfaces provided by the carrier system 120 to enter or update claims. For example, call center representatives may enter loss claim data while speaking to a property owner. Numerous other functionality provided by an insurance carrier may be implemented within the carrier system 120. In some instances, the carrier system 120 may comprise, or may be one in the same as a client device 122 that may communicate with the disbursement authorization data object processing system 105 such as via disbursement authorization API 115.

In this regard, a user device 110 accessing a carrier system 120 may enter data that when processed by the carrier system 120, engages the client device 122 to invoke the disbursement authorization API 115, such as by transmitting a disbursement authorization data object.

In an example embodiment, the disbursement authorization data object processing system 105 may also be in communication with a real-time status reporting system 130 such as one associated with a financial institution that is a mortgagee of an insured property. A real-time status reporting service 134 may be provided by the real-time status reporting system 130 for providing real-time status data to the disbursement authorization data object processing system 106, such as but not limited to a mortgage balance, a delinquency indicator, days past due, and/or the like. The real-time status reporting system(s) 130 may further provide a multitude of services on behalf of a financial institution such as those related to processing loan payments, managing escrow accounts and payments therefrom, funding new loans, processing payoffs, and/or the like.

### Example Apparatus for Implementing Embodiments of the Present Disclosure

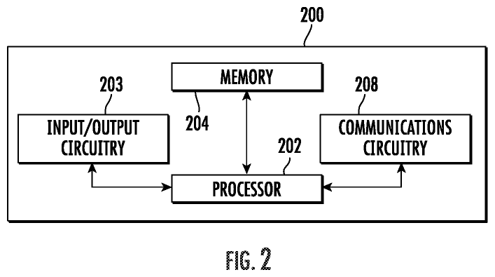

The disbursement authorization data object processing system 105 may comprise or be embodied by one or more computing systems, such as apparatus 200 shown in FIG. 2. An example apparatus 200 may additionally implement any of the user device(s) 118, client device(s) 122, carrier system(s) 120, real-time status reporting system(s) 130, and/or real-time status reporting service 134.

Apparatus 200 may include a processor 202, a memory 204, input/output circuitry 203, and communications circuitry 208. The apparatus 200, when implemented as the disbursement authorization apparatus 108 may be configured, using the memory 204 and/or one or more of the processor 202, input/output circuitry 203, and communications circuitry 208 to execute the operations described herein.

Although the components are described with respect to functional limitations, it should be understood that the particular implementations necessarily include the use of particular hardware. It should also be understood that certain components of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry,” as defined above, should be understood to include hardware and, in some embodiments, software for configuring the hardware. For example, in some embodiments, “circuitry” may include processing circuitry, storage media, network interfaces, input/output devices, and the like. In some embodiments, other elements of the apparatus 205 may provide or supplement the functionality of particular circuitry. For example, the processor 202 may provide processing functionality, the memory 204 may provide storage functionality, the communications circuitry 208 may provide network interface functionality, and the like.

In some embodiments, the processor 202 (and/or co-processor or any other processing circuitry assisting or otherwise associated with the processor) may be in communication with the memory 204 via a bus for passing information among components of apparatus 200. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus 200 and/or disbursement authorization apparatus 108 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure. Alternatively, as another example, when the processor is embodied as an executor of software instructions, the instructions may specifically configure the processor to perform the algorithms and/or operations described herein when the instructions are executed.

In some embodiments, apparatus 200 may include input/output circuitry 203 that may, in turn, be in communication with processor 202 to provide output to the user and, in some embodiments, to receive an indication of a user input. The input/output circuitry 203 may comprise a user interface and may include a display, a web user interface, a mobile application, a client device, a kiosk, or the like. In some embodiments, the input/output circuitry 203 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna(s) to cause transmission of signals via the antenna(s) or to handle receipt of signals received via the antenna(s).

The communications circuitry 208 includes hardware and software configured to support amongst components of computing environment 100. The communications circuitry 208 may utilize processing circuitry, such as the processor 202, to facilitate such communications. It should also be appreciated that, in some embodiments, the communications circuitry 208 may include a separate processor, specially configured field programmable gate array (FPGA), or application specific interface circuit (ASIC).

It is also noted that all or some of the information discussed herein can be based on data that is received, generated and/or maintained by one or more components of the disbursement authorization data object processing system 105. In some embodiments, one or more external systems (such as a remote cloud computing and/or data storage system, carrier system(s) 120, real-time status reporting system(s) 130, and/or the like) may also be leveraged to provide at least some of the functionality discussed herein.

As described above and as will be appreciated based on this disclosure, embodiments of the present disclosure may be configured as methods, mobile devices, frontend graphical user interfaces, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Example Processes

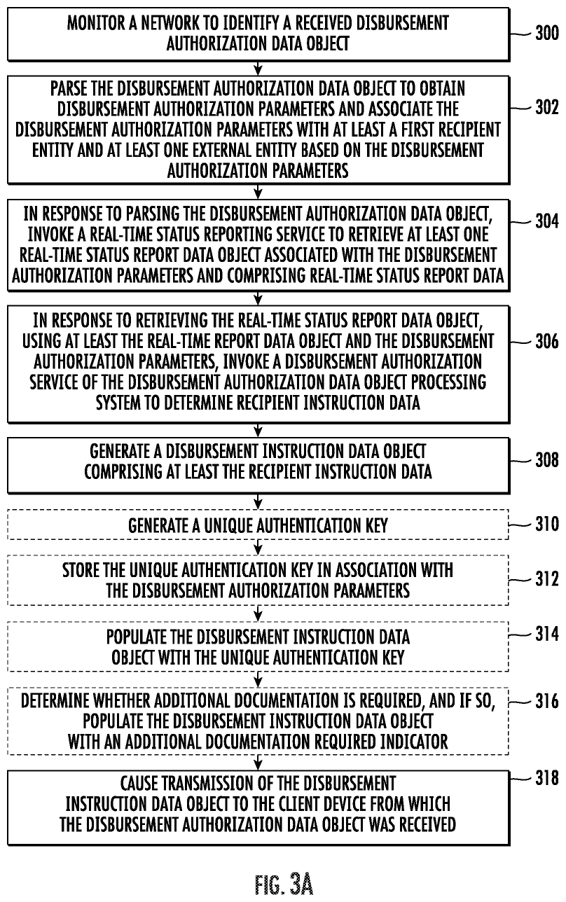

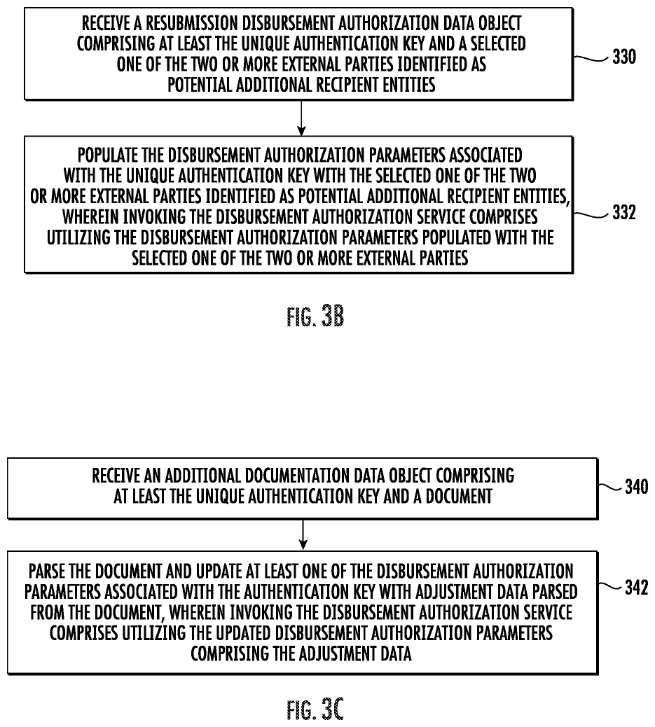

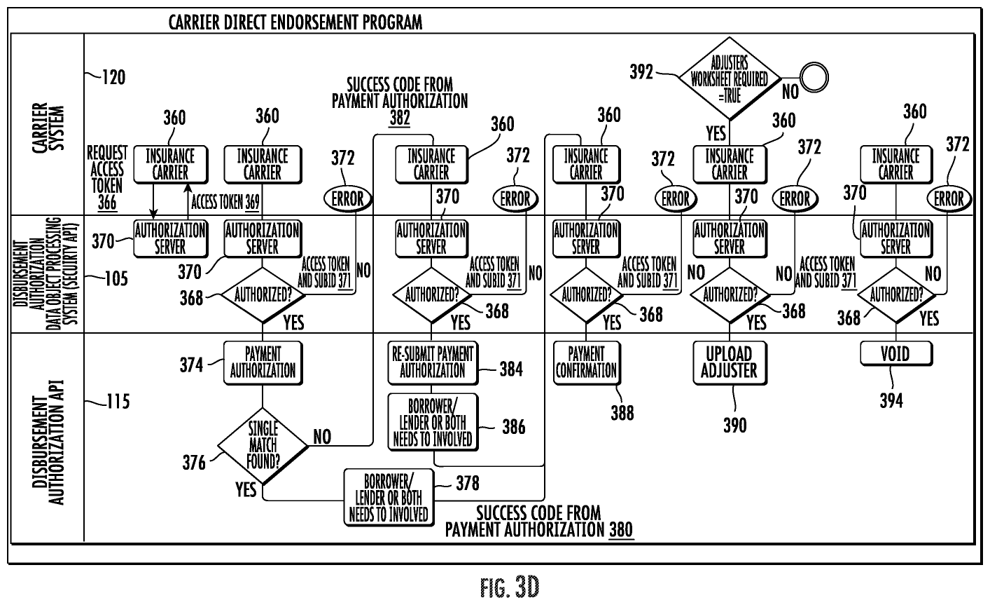

FIG. 3A is a flowchart of operations that may be performed by the disbursement authorization apparatus 108 according to example embodiments. Certain operations may be considered optional, as indicated by the dashed lines. As shown by operation 300, the disbursement authorization apparatus 108 may include means, such as memory 204, processor 202, communications circuitry 208 and/or the like, for monitoring a network to identify a received disbursement authorization data object. The disbursement authorization data object may be received from a client device 122 and/or carrier system 120 and includes various information relating to a claim. The client device 122 and/or carrier system 120 may initiate transmittal of the disbursement authorization data object in response to a user submitting claim details via a user interface, such as one maintained by the carrier system 120. The various carrier systems 120 may transmit disbursement authorization data objects via the disbursement authorization API 115.

The disbursement authorization data object enables the carrier system 120 and/or client device 122 to initiate a search for policies and/or associated loans, and/or request a disbursement authorization from the disbursement authorization apparatus 108. According to certain embodiments, the carrier system 120 and/or client device 122 may initiate a POST request passing disbursement authorization parameters in the request body. For example, according to embodiments in which the carrier system 120 and/or client device 122 utilizes JavaScript Object Notation (JSON), the disbursement authorization data object may be considered a set of header parameters passed by the carrier system 120 and/or client device 122.

As shown by operation 302, disbursement authorization apparatus 108 may include means, such as memory 204, processor 202, and/or the like, for parsing the disbursement authorization data object to obtain disbursement authorization parameters and associating the disbursement authorization parameters with at least a first recipient entity and at least one external entity based on the disbursement authorization parameters. Various insurance carriers may have their own respective systems that process and house data in a variety of formats, and the parsing of the disbursement authorization data object by the disbursement authorization apparatus 108 enables the disbursement authorization apparatus 108 to standardized certain fields and records. Table 1 below provides an example request schema representative of a disbursement authorization data object, along with example data with which respective fields may be populated. Each row reflects a disbursement authorization parameter that may be parsed from the disbursement authorization data object.

TABLE 1

| | | Required/ | | Field | |
|---|---|---|---|---|---|
| | Field Name | Optional | Data type | Description | Example |
| 1 | insurerName | Required | String | Insurer | Your Carrier Name |
| 2 | carrierName | Required | String | Carrier | Your Carrier Name |
| | | | | Name/ | |
| 3 | loanNumber | Optional | String | Loan | 0005553333 |
| 4 | policyNumber | Required | String | Policy | 123XYZ13 |
| 5 | mortgageeClauseName | Required | String | Mortgagee | Bank XYZ |
| | | | | Clause | |
| 6 | mortgageeClauseAddress | Required | String | Mortgagee | PO Box 100515 |
| | | | | Clause | |
| 7 | mortgageeClauseZip | Required | String | Mortgagee | 29502 |
| | | | | Clause | |
| 8 | carrierClaimNumber | Required | String | Carrier | [Your Unique Claim Number] |
| | | | | Claim | |
| 9 | Dol | Required | String(date- | Date of | YYYY-MM-DD |
| | | | time) in UTC | Loss | |
| 10 | Col | Required | String | Cause of | Hail |
| 11 | isPublicAdjusterAssigned | Optional | Boolean | Is there a | True/False |
| | | | | Public | |
| | | | | Adjuster? | |
| 12 | issueDate | Optional | String(date- | Payment | YYYY-MM-DD (or Null/blank) |
| | | | time) in UTC | issue date | |
| 13 | checks | Required | Array[CheckDetail] | The amount | “checkNumber”: |
| | | | | of your | “IB123987”, “Amount”: |
| | | | | check(s) | 1250.00, “Payees”: |
| | | | | | “Mickey Mouse; Minnie |
| | | | | | Mouse” |
| 14 | checkNumber | Optional | CheckDetail | Check | LW2228585 |
| 15 | Amount | Required | CheckDetail | Payment | 1250.00 |
| 16 | Payees | Optional | CheckDetail | Payee | Bob Customer; Kamila |
| 17 | propertyAddress | Required | String | Property | 5555 NW GARDEN STONE DR |
| 18 | propertyCity | Optional | String | Property | Batavia |
| 19 | propertyState | Optional | String | Property | NY |
| 20 | propertyZip | Required | String | Property | 14422 |

The disbursement authorization parameter on line 16, payees, may indicate the first recipient entity, such as a property owner associated with the claim. The first recipient entity may include a person's name, business name, or a combination thereof, including multiple names. The disbursement authorization parameter on line 5, the mortgagee clause name, may be considered the external entity, such as a lender. Other disbursement authorization parameter may include any of those provided in Table 1. The disbursement authorization apparatus 108 may store any of the disbursement authorization parameters on repository 106 for claims tracking and reconciliation purposes.

The following example code segment includes another example request utilizing the disbursement authorization data object according to the schema in Table 1.

{
“insurerName”: “Your Carrier name”,
“loanNumber”: “0005553333”,
“policyNumber”: “123XYZ13”,
“mortgageeClauseName”: “Bank XYZ”,
“mortgageeClauseAddress”: “PO Box 5954”,
“mortgageeClauseZip”: “45501”,
“carrierClaimNumber”: “ABC123456”,
“dol”: “2020-07-30T04:00:00.000Z”,
“col”: “Fire”,
“isPublicAdjusterAssigned”: false,
“issueDate”: “2020-08-09T04:00:00.000Z”,
“checks”: [
{
“checkNumber”: “IB123987”,
“Amount”: 1250.00,
“Payees”: “Mickey Mouse; Minnie Mouse”
}
],
“propertyAddress”: “123 Main St”,
“propertyCity”: “Santa Ana”,
“propertyState”: “CA”,
“propertyZip”: “92705”,
“carrierName”: “Your Carrier Name”
}

It should be appreciated that because multiple carrier systems 120 may be operative in the computing environment 100, some disbursement authorization parameters may be in different formats than the disbursement authorization parameters provided by different carrier systems, and/or a different format than what is stored by the disbursement authorization data object processing system 105 and/or repository 106. For example, some loan numbers may be stripped of hyphens, leading and/or trailing insignificant digits, and/or the like, while other instances may include them. Still further, certain disbursement authorization parameters, such as those indicated as optional in Table 1, may be omitted from some disbursement authorization data objects, but included in others. In this regard, in certain embodiments, after parsing a distribution authorization data object, the disbursement authorization apparatus 108 may standardize the data by populating certain distribution authorization parameters in repository 106, and/or reformatting certain distribution authorization parameters, such as by performing certain search and matching algorithms and/or referencing data stored in repository 106.

As shown by operation 304, the disbursement authorization apparatus 108 may include means, such as memory 204, processor 202, communications circuitry 208 and/or the like, for in response to parsing the disbursement authorization data object, invoking a real-time status reporting service to receive at least one real-time status report data object associated with the disbursement authorization parameters and comprising real-time status report data. In this regard, the disbursement authorization apparatus 108 may identify a real-time status reporting service 134 associated with the real-time status reporting system 130 that is associated with the external entity (e.g., mortgagee or lender such as identified in row 5 of Table 1). The disbursement authorization apparatus 108 may access a routing table and/or the like on repository 106, to determine instructions for invoking the real-time status reporting service associated with the external entity indicated by the disbursement authorization parameters.

In some embodiments, the disbursement authorization apparatus 108 may generate a request to the real-time status reporting service in a format required by the particular real-time status reporting service. Because various real-time status reporting services may be implemented within the computing environment 100, and various requests are routed from various carrier systems 120, such requests may need to be formatted according to the particular service's standards. For example, dependent upon the particular real-time status reporting system 130 associated with a request, the disbursement authorization apparatus 108 may standardize data by reformatting certain distribution authorization parameters, such as by performing certain search and matching algorithms and/or referencing data stored in repository 106.

The request may be transmitted over the network, and real-time status report data may be returned to the disbursement authorization apparatus 108. The real-time status report data included in the real-time status report data object may include a mortgage balance, delinquency indicator, days delinquent, and/or the like.

As shown by operation 306, the disbursement authorization apparatus 108 may include means, such as memory 204, processor 202, communications circuitry 208 and/or the like, for in response to retrieving the real-time status report data object, using at least the real-time status report data object and the disbursement authorization parameters, invoking a disbursement authorization service of the disbursement authorization data object processing system, to determine recipient instruction data.

The disbursement authorization service may be implemented by the disbursement authorization data object processing system 105 and in some circumstances, may provide a response indicating whether additional information is needed, such as adjuster details, and/or selection of a primary lienholder from a plurality of lienholders or mortgagees to include as additional recipient on a disbursement. In certain embodiments and scenarios, a response may additionally or alternatively indicate whether including an external entity identified as an additional payee is required, optional, and/or not needed (e.g., dual endorsement waiver).

According to certain example embodiments the disbursement authorization apparatus 108 may determine whether multiple matches of a potential external recipient entity (e.g., mortgagee) are located. In such an example, the disbursement authorization apparatus 108 may return multiple options for selection of an external recipient entity at the carrier system 120, as described in further detail below.

According to certain example embodiments, invoking the disbursement authorization service comprises utilizing the disbursement authorization parameters and the real-time status report data to process at least one external entity rule set associated with the disbursement authorization parameters. In certain embodiments, invoking the disbursement authorization service comprises utilizing the disbursement authorization parameters and the real-time status report data to process at least one client rule set associated with the client device from which the disbursement authorization data object was received. In some embodiments, the processing of the various rule sets enables example embodiments to generate, modify, and/or track an additional recipient entity parameter. In some embodiments, the additional recipient entity parameter may accumulate outputs from the various rule sets to arrive at or determine a recipient instruction data. As another example, if any rules processed as a part of the disbursement authorization service indicate at least one external entity is required, the disbursement authorization apparatus 108 may set the additional recipient entity parameter to ‘true,’ indicating the external entity is required as an additional recipient entity. According to certain embodiments, all rules must return an indication that the external entity is not required as an additional recipient entity to determine dual endorsement can be waived.

The additional recipient entity parameter may therefore be a Boolean value, or in some embodiments may be a quantitative measure to be compared against a predefined threshold to determine a recipient instruction status code, having various optional values, examples of which are provided in Table 2 below. For example, different numerical ranges of the determined additional recipient entity parameter may have different associated recipient instruction status codes such as those in Table 2.

Any number of recipient instruction status codes such as that in line 14 of Table 1 may be used to communicate various instructions and/or statuses to the carrier system 120 and/or client device 122. Examples of recipient instruction status codes that may be populated in the disbursement instruction data object, and their respective meanings are provided in Table 2 below.

TABLE 2

| | API Status | | | |
|---|---|---|---|---|
| | Code/ | | | |
| HTTP | Recipient | | | |
| Status | Instruction | | | |
| Code | Status Code | Message | Success | Example |
| 200 | 1000 | Payment Instruction Generated - Direct | TRUE | Direct to |
| | | to Borrower | | Borrower |
| | 2000 | Payment Instruction Generated - | TRUE | Include Lender |
| | | Include Lender | | |
| | 200 | Special Handling - No Payment Instruction | TRUE | Include Lender |
| | 200 | Loan Found - Not Serviced | TRUE | Include Lender |
| | 300 | Multiple Matches Found | FALSE | NA |
| | 300 | Loan Not Found - Unable to Serve | FALSE | NA |
| | 310 | Retriable or Temporary Error | FALSE | NA |
| 400 | N/A | Bad Request | NA | NA |
| 401 | N/A | Unauthorized | NA | NA |
| 500 | N/A | Internal Server Error (includes all unhandled | NA | NA |
| | | exception as well as other catched | | |
| | | exceptions that are not handled) | | |

As introduced above, various rules are processed to determine the recipient instruction status code. A client rule set may comprise any number of client rules associated with an insurance carrier and/or carrier system 120, and may vary across different insurance carriers. Examples of a client rule include that an adjuster's report may be required for claim amounts over a pre-determined amount. In some examples, a client rule may be configured by computer program code to include the same logic, but may reference different parameters and/or thresholds defined by a respective insurance carrier. Different insurance carrier may set different parameters and/or configure different rules accordingly.

The external entity rule set may include any number of external entity rules defined by an external entity and/or associated real-time status reporting system 130, such as one associated with a lender. The external entity rules may indicate, for example, that dual endorsement is required when the claim amount comes within a pre-determined percent threshold of the equity a property owner has in the property, which is dependent upon the real-time status data.

According to operation 308, disbursement authorization apparatus 108 may include means, such as memory 204, processor 202, and/or the like, for generating a disbursement instruction data object comprising at least a recipient instruction data according to whether the real-time status report data and the disbursement authorization parameters satisfy a disbursement instruction parameter. An example schema of the disbursement instruction data object is provided below in Table 3.

TABLE 3

| | | Data | Field | |
|---|---|---|---|---|
| | Field Name | Type | Description | Example |
| 1 | multipleLoanFound | Array[Multiple | Array of multiple loan | Array populated when |
| | | MatchDetails] | match details | multiple loan matches |
| | | | | are found |
| 2 | policyNumber | MultipleMatchDetails | Policy Number | 36CFE252456789s |
| | | {String} | | |
| 3 | customerName | MultipleMatchDetails | Customer name | Michelle Robertson |
| | | {String} | | |
| 4 | mortgageeAddress | MultipleMatchDetails | Mortgagee Address | PO Box 4500 |
| | | {String} | | |
| 5 | propertyAddress | MultipleMatchDetails | Property Address | 555 S FRONT ST |
| | | {String} | | |
| 6 | last4LoanNumber | MultipleMatchDetails | Last 4 digit of loan number | 5398 |
| | | {String} | | |
| 7 | matchedLoanLocator | MultipleMatchDetails | Unique loan key provided to | 7081409235398 |
| | | {String} | you | |
| 8 | paymentInstruction | String | Payment Instruction Result | Include Lender on claim |
| | | | | payment for payment |
| | | | | request of $2,000.00. |
| 9 | trackingNo | Integer | Tracking/claim Number | 5195781 |
| | | | provided by disbursement | |
| | | | authorization data object | |
| | | | processing system | |
| 10 | paymentInstructionId | Integer | Payment Instruction ID | 5299 |
| 11 | adjustersWorksheetRequired | Boolean | Adjuster's Worksheet | true |
| | | | Required | |
| 12 | resubmissionKey | String(uuid) | | Populated only when |
| | | | | multiple matches are [symbol] |
| 13 | success | Boolean | | true |
| 14 | code | Integer | | 200 |
| 15 | message | String | | Payment Instruction |
| | | | | Generated |

[symbol]

indicates data missing or illegible when filed

For example, the field in row 1 may be utilized if multiple loans are identified, and may include data relating to the multiple identified loans and associated external entities. Such scenarios may result in the carrier system 120 providing a selection of an external entity, such as the primary lienholder, as described in further detail below with reference to the flowchart of FIG. 3B. Lines 2-7 may include various details regarding the policy and/or related loan. According to certain embodiments and certain scenarios, not every field of the disbursement instruction data object is populated. For example, if multiple loans and/or potential external entities are identified as potential payees, a recipient instruction data may not yet be determined, but may be subsequently determined in response to receiving additional data at the disbursement authorization data object processing system 105. Such additional data may be requested from the carrier system 120 and/or client device 122 as described in further detail below.

Table 3 reflects an example in which the recipient instruction data has been determined, according to whether the real-time status report data and the disbursement authorization parameters. Line 8 of Table 3 indicates the payment instruction which may be included in the recipient instruction data as is determined according to example embodiments provided herein, based on the additional recipient entity parameter. Examples of the recipient instruction data includes “Include lender on claim payment,” “Lender not required on payment,” and/or the like.

In certain embodiments, as shown in optional operation 310, disbursement authorization apparatus 108 may include means, such as memory 204, processor 202, and/or the like, for generating a unique authentication key, such as but not limited to the resubmission key of line 12 in Table 3 above. In operation 312, disbursement authorization apparatus 108 may include means, such as memory 204, processor 202, and/or the like, for storing the unique authentication in association with the disbursement authorization parameters. In this regard, the disbursement authorization data object processing system 105 stores the unique authentication for tracking purposes and reconciliation as additional communications relating to the claim are received.

Accordingly, as shown in operation 314, disbursement authorization apparatus 108 may include means, such as memory 204, processor 202, and/or the like, for populating the disbursement instruction data object with the unique authentication key, such as the resubmission key of line 12.

An example code segment of a populated disbursement instruction data object, for a scenario in which an external entity is not required as a payee is provided below.

{
“multipleLoanFound”: [ ],
“paymentInstruction”: “Direct to Borrower payment authorized for payment request of $7411.06.
Do not include lender on payment.”,
“trackingNo”: 7286522,
“paymentInstructionId”: 15013,
“adjustersWorksheetRequired”: true,
“success”: true,
“code”: 1000,
“message”: “Payment Instruction Generated - Direct To Borrower”
}

Another example of a code segment of a populated disbursement instruction data object is provided below. According to the example below, multiple loans were identified.

{
“multipleLoanFound”: [
{
“policyNumber”: “12588371ABC1”,
“customerName”: “John Smithington”,
“mortgageeAddress”: “PO Box 4500”,
“propertyAddress”: “555 S FRONT ST”,
“last4LoanNumber”: “5398”,
“matchedLoanLocator”: “7081409235398”
},
{
“policyNumber”: “12588371ABC2020”,
“customerName”: “Michelle Robertson”,
“mortgageeAddress”: “PO Box 4500”,
“propertyAddress”: “555 S FRONT ST”,
“last4LoanNumber”: “2157”,
“matchedLoanLocator”: “1061143262157”
}
],
“paymentInstruction”: “string”,
“trackingNo”: 5195781,
“paymentInstructionId”: 5299,
“adjustersWorksheetRequired”: true,
“resubmissionKey”: “804362d5-7345-4641-822a-1efe8d6e23c2”,
“success”: false,
“code”: 3000,
“message”: “Multiple Matches Found”
}

According to certain example embodiments, in operation 316, disbursement authorization apparatus 108 may optionally include means, such as memory 204, processor 202, and/or the like, for determining whether additional documentation is required, and if so, populating the disbursement instruction data object with an additional documentation required indicator, such as the field of line 11 of Table 3, indicating whether an adjuster worksheet is required.

As shown in operation 318 of FIG. 3A, the disbursement authorization apparatus 108 may include means, such as memory 204, processor 202, communications circuitry 208 and/or the like, for causing transmission of the disbursement instruction data object to the client device from which the disbursement authorization data object was received. The disbursement authorization apparatus 108 may reference a client device identifier stored in association with the disbursement authorization data object. In this regard, the disbursement instruction data object is returned to the carrier system 120 and/or client device 122, which can perform a multitude of operations in response to receipt of the disbursement instruction data object.

According to certain embodiments, the transmission of the disbursement instruction data object to the client device from which the disbursement authorization data object was received occurs in real-time or near real-time relative to when the associated disbursement authorization data object was received by the disbursement authorization apparatus 108. This enables subsequent operations, such as the display of any related data via a user device 110, to occur in real-time or near real-time in response to related claim data being entered by a user of the carrier system 120. The term near real-time accounts for short delays, such as milliseconds or seconds, incurred due to computer processing time.

In examples such as those in which the disbursement authorization data object processing system 105 is engaged via the disbursement authorization API 115, a service operation on the carrier system 120 and/or client device 122 may process the disbursement instruction data object accordingly. For example, when no additional user input or processing is required, the carrier system 120 may engage a payment system to authorize and initiate a check disbursement. Such transactions may be queued for distribution and/or stored for batch processing to initiate disbursement.

According to certain examples, the carrier system 120 and/or client device 122 may cause data from the disbursement instruction data object to be rendered for display on a user device 110. In certain embodiments, an internal user of the carrier system 120 and/or client device 122 reviews and confirms, with user device 110, certain data prior to submitting for subsequent processing and remittance.

As another example, an internal user of the carrier system 120 may select a loan from multiple loans returned in the disbursement instruction data object, details of which are rendered on the user device 110 for selection. Further details are described with respect to FIG. 3B below. As another example, an adjuster may access a user interface of the carrier system 120 to view certain loan and/or disbursement details, and upload an adjuster's worksheet to the disbursement authorization data object processing system 105. Further details are described below with respect to FIG. 3C below.

FIGS. 3B and 3C are flowcharts of operations performed by the disbursement authorization apparatus 108. As shown by operation 330 of FIG. 3B, the disbursement authorization apparatus 108 may include means, such as memory 204, processor 202, communications circuitry 208 and/or the like, for receiving a resubmission disbursement authorization data object comprising at least the unique authentication key and a selected one of two or more external entities identified as potential additional recipient entities.

According to certain embodiments, the selection of one of two or more external entities may be indicated by the matched loan locator of row 2 of Table 4 below. Table 4 is an example schema of a resubmission disbursement authorization data object received by the disbursement authorization apparatus 108.

TABLE 4

| | FiwldFFileFiel Field | Required/ | | | |
|---|---|---|---|---|---|
| | Name | Optional | String(uuid) | Resubmission Key | Example |
| 1 | resubmissionKey | Required | String(uuid) | Resubmission Key | 804362d5-7345- |
| | | | | | 4641-822a- |
| | | | | | 1efe8d6e23c2 |
| 2 | matchedLoanLocator | Required | String | Unique loan key | 123332142 |
| | | | | previously provided by | |
| | | | | disbursement | |
| | | | | authorization data object | |
| | | | | processing system | |
| 3 | policyNumber | Required | String | Policy Number | 12588371A2020 |
| 4 | carrierClaimNumber | Required | String | Carrier Claim Number | ABC123456 |

An example corresponding code segment is provided below:

{
“resubmissionKey”: “804362d5-7345-4641-822a-1efe8d6e23c2”
“matchedLoanLocator”: “1061143262157”,
“policyNumber”: “125883710ABC2020”,
“carrierClaimNumber”: “ABC123456”
}

The unique authentication key may be provided as a resubmission key in row 1, enabling the disbursement authorization apparatus 108 to reference the corresponding claim and/or disbursement authorization data object in repository 106. An internal user of the carrier system 120 may select a loan from multiple loans returned in the disbursement instruction data object, and the carrier system 120 and/or client device 122 may populate the resubmission disbursement authorization data object as set forth in Table 4, and initiate transmission thereof to the disbursement authorization apparatus 108. When the disbursement instruction data object is returned in real-time or near real-time to the client device 122, a user that entered initial claim details to initiate transmission of the disbursement authorization data object, may make the further selection of the loan during the same session in which the claim data was provided. The disbursement authorization data object processing system 105 therefore provides improvements to prior disbursement authorization data object processing systems by enabling real-time integration amongst various components of the computing environment 100, including but not limited to the real-time status reporting service 134, the carrier system 120, and/or the like, and further enables real-time interactions by a user of the carrier system 120 to confirm, modify and/or edit certain information.

Accordingly, in operation 332, the disbursement authorization apparatus 108 may include means, such as memory 204, processor 202, and/or the like, for populating the disbursement authorization parameters associated with the unique authentication key with the selected one of the two or more external entities identified as potential additional recipient entities. In this regard, the disbursement authorization apparatus 108 may utilize the unique authentication key such as the resubmission key in row 1 of Table 4 to access the corresponding disbursement authorization parameters on repository 106. Based on the data provided in the resubmission disbursement authorization data object, the disbursement authorization apparatus 108 populates or modifies certain fields as provided in the resubmission disbursement authorization data object. The matched loan locator in row 2 of Table 4 represents the selected one of the two or more external entities identified as potential additional recipient entities. The policy number in row 3 and/or carrier claim number in row 4 may further identify the associated disbursement authorization parameters to be updated.

Upon completion of operation 332, the disbursement authorization apparatus 108 may perform operation 304 and/or 306 (and/or other operations) of FIG. 3A, and in some instances, for an additional time for the same claim, following selection of a particular lender and/or external entity at the carrier system 120 and/or client device 122. Accordingly, the real-time status reporting service 134 corresponding to the selected lender and/or external entity may be invoked to determine real-time status data. The disbursement authorization service may again be invoked to determine whether the at least one selected external entity is required as an additional recipient entity. Additional operations of FIG. 3A may be repeated accordingly, such as the re-processing of rules, and/or generation of an additional disbursement instruction data object, such as that of Table 3, to be transmitted to the associated carrier system 120 and/or client device 122.

It will be appreciated that in a scenario of a response to a resubmission disbursement authorization data object, according to certain embodiments, the disbursement instruction data object may be an abbreviated version of that presented in Table 3. For example, the below schema may be used for a resubmission disbursement instruction data object, which is an abbreviated version of the disbursement instruction data object of Table 3, because certain data is assumed to be consistent with the previously transmitted disbursement instruction data object.

TABLE 5

| | | Data | Field | |
|---|---|---|---|---|
| | Field Name | Type | Description | Example |
| 1 | paymentInstruction | String | Payment Instruction | Direct to Borrower |
| | | | Result | payment authorized for |
| | | | | payment request |
| | | | | of $7411.06. Do |
| | | | | not include lender |
| 2 | trackingNo | Integer | Tracking/Claim Number | 7286522 |
| | | | provided by disbursement | |
| | | | authorization data | |
| | | | object processing | |
| | | | system | |
| 3 | paymentInstructionId | Integer | Payment Instruction ID | 15013 |
| 4 | adjustersWorksheetRequired | Boolean | Indicated Adjuster's | true |
| | | | Worksheet required | |
| | | | by disbursement | |
| | | | authorization data | |
| | | | object processing | |
| | | | system | |
| 5 | success | Boolean | | true |
| 6 | code | Integer | | 1002 |
| 7 | message | String | | Loan found |
| | | | | Payment |
| | | | | Instruction |
| | | | | generated. |

A example corresponding code segment is provided below.

```
{
  “paymentInstruction”: “Direct to Borrower payment authorized for payment request of
  $7411.06. Do
not include lender on payment.”,
  “trackingNo”: 7286522,
  “paymentInstructionId”: 15013,
  “adjustersWorksheetRequired”: true,
  “success”: true,
  “code”: 1002,
  “message”: “ Loan found Payment Instruction generated ”
}
```

Example codes that may be referenced in the resubmission disbursement instruction data object, such as that of Table 5, are provided below in Table 6.

TABLE 6

| | API Status | | | |
|---|---|---|---|---|
| | Code/ | | | |
| HTTP | Recipient | | | |
| Status | Instruction | | | |
| Code | Status Code | Message | Success | Payment Instruction |
| 200 | 1000 | Payment Instruction Generated - | TRUE | Direct to Borrower |
| | | Direct to Borrower | | |
| | 2000 | Payment Instruction Generated - | TRUE | Include Lender |
| | | Include Lender | | |
| | 2001 | Special Handling - No Payment | TRUE | Include Lender |
| | | Instruction | | |
| | 2002 | Loan Found - Not Serviced/Loan | TRUE | Include Lender |
| | | Not Found Unable to Serve | | |
| | 3100 | Retriable Error or Temporary Error | FALSE | NA |
| 400 | NA | Bad Request | NA | NA |
| 401 | NA | Unauthorized | NA | NA |
| 500 | NA | Internal Server Error (includes | NA | NA |
| | | all unhandled exception as | | |
| | | well as other catched | | |
| | | exceptions that are not | | |
| | | handled) | | |

As shown by operation 340 of FIG. 3B, the disbursement authorization apparatus 108 may include means, such as memory 204, processor 202, communications circuitry 208 and/or the like, for receiving an additional documentation data object comprising at least the unique authentication key and a document.

Table 7 is an example schema of an additional documentation data object received by the disbursement authorization apparatus 108.

TABLE 7

| | | Required/ | | | |
|---|---|---|---|---|---|
| | Field Name | Optional | Data Type | Field Description | Example |
| 1 | TrackingNo | Required | Integer | Tracking/Claim Number | 7286522 |
| | | | | provided by disbursement | |
| | | | | authorization data | |
| | | | | object processing | |
| | | | | system | |
| 2 | PaymentInstructionId | Required | Integer | Payment Instruction ID | 15013 |
| 3 | File | Required | File | Adjuster's Worksheet File | File.PDF |

The unique authentication key may be provided as a tracking number in row 1, enabling the disbursement authorization apparatus 108 to reference the corresponding claim and/or disbursement authorization data object in memory 204 and/or repository 106. An internal user of the carrier system 120, such as an adjuster may upload a document, such as an adjuster's worksheet in portable document format (PDF), as indicated by row 3. The payment instruction identifier of line 2 may enable further reconciliation and/or matching by the carrier system 120, client device 122, and/or disbursement authorization data object processing system 105. Such data may be selected by or entered by the adjuster via a user interface when uploading the document. A code segment corresponding to Table 7 is provided below and provides an example request body.

curl--location--request POST ‘implentationurl/Upload’\
--header ‘Ocp-Apim-Subscription-Key: ************************’\
-header ‘Authorization: Bearer *****************************’\
-header ‘Cookie: *********************************’\
--form ‘TrackingNo=7286522’\
--form ‘PaymentInstructionId=15013’\
--form ‘=@/path/to/file.txt’

As shown in operation 342, the disbursement authorization apparatus 108 may include means, such as memory 204, processor 202, and/or the like, for parsing the document and updating at least one of the disbursement authorization parameters associated with the authentication key, with adjustment data parsed from the document, wherein invoking the disbursement authorization service comprises utilizing the updated disbursement authorization parameters comprising the adjustment data

An adjuster's worksheet may be in various layouts and/or formats dependent on the adjuster, associated carrier system 120 and/or client device 122 by which the document was uploaded, and/or the like. The processor 202 of the disbursement authorization apparatus 108 may perform a process, such as optical character recognition (OCR) to convert the PDF into computer-readable data. The processor 202 of the disbursement authorization apparatus 108 then parses the data, regardless of its format or layout which may vary dependent on the carrier system 120, into the standardized disbursement authorization parameters stored in repository 106. In this regard, certain fields may be updated and/or populated according to the document. In certain scenarios, changes to certain fields, such as the claim amount, may impact the disbursement instruction data object.

Accordingly, upon completion of operation 342, the disbursement authorization apparatus 108 may perform operation 304, 306 (and/or other operations) of FIG. 3A, and in some instances, for an additional time for the same claim, following uploading of the additional documentation at the carrier system 120 and/or client device 122. Accordingly, the real-time status reporting service corresponding to the selected lender and/or external entity may be invoked to determine real-time status data. The disbursement authorization service may again be invoked to determine whether the at least one selected external entity is required as an additional recipient entity, such as based on the additional documentation provided. Additional operations of FIG. 3A may be repeated accordingly, and an additional disbursement instruction data object, such as that of Table 3, may be transmitted to the associated carrier system 120 and/or client device 122.

It will be appreciated that in the scenario of a response to an additional documentation data object, according to certain embodiments, the disbursement instruction data object may be an abbreviated version of that presented in Table 3. For example, the below schema in Table 6 may be configured as a post-adjustment disbursement instruction data object, which is an abbreviated version of the disbursement instruction data object of Table 3. In certain examples, such as that of Table 6, the additional documentation uploaded to the disbursement authorization apparatus 108 does not impact the disbursement instruction data. In this regard, a data object indicating success or failure, and/or an associated code may be transmitted.

TABLE 8

| | | Data | Field | |
|---|---|---|---|---|
| | Field Name | Type | Description | Example |
| 1 | success | Boolean | success | true |
| 2 | code | Integer | code | 200 |
| 3 | Message | String | | Document uploaded |

Below is an example code segment corresponding to the post-adjustment disbursement instruction data object of Table 6.

```
  {
    “success”: true,
    “code”: 200,
“message”: “File uploaded”
}
```

Below is a table of upload status codes that may be utilized in the response.

TABLE 9

| | API Status | | |
|---|---|---|---|
| HTTP | Code/ | | |
| Status | Upload Status | | |
| Code | Code | Message | Success |
| 200 | 200 | Success | TRUE |
| | 300 | Upload failed - (reason) | FALSE |
| | 310 | Retriable Error or Temporary Error | FALSE |
| 400 | | Bad Request | NA |
| 401 | | Unauthorized | NA |
| 500 | | Internal Server Error (includes all | NA |
| | | unhandled exception as well as other | |
| | | catched exceptions that are not | |
| | | handled) | |

The carrier system 120 and/or client device 122 may display feedback regarding the success of uploading the document, based on the received post-adjustment disbursement instruction data object.

FIG. 3D is a flowchart of operations performed by and/or provided by the carrier system 120, security API of the disbursement authorization data object processing system 105, and the disbursement authorization API 115 of the disbursement authorization data object processing system 105. The authorization server 370 may be implemented within the distribution authorization system 105.

The insurance carrier 360 initiates various calls via the carrier system 120 to the disbursement authorization data object processing system 105. At 366, the insurance carrier 360 (e.g., carrier system 120) requests an access token from the authorization server 370. If authenticated, the authorization server 370 returns an access token 369 to the insurance carrier 360. In another subprocess, if the access token and sub ID indicate the requesting insurance carrier 360 is not authorized (368), an error is returned at 372. This authentication process may be repeated for other subprocesses illustrated in FIG. 3D. If authorized at 368, processing continues to 374, in which the disbursement authorization API 115 invokes the disbursement authorization apparatus 108 to identify loans associated with the claim or request. If a single match is found at 376, the disbursement authorization apparatus 108 determines at 378 if the borrower, lender, or both needs to be involved. A success code 380 is returned to the insurance carrier 360. If a single match is not found at 376 (e.g., multiple matches are found), a success code at 382 (which may be different than the success code 380) is returned to the insurance carrier 360, prompting the insurance carrier 360 to select one loan and/or lender that is the primary lender associated with the property. When the insurance center 360 re-authenticates with access token and sub ID at 371, if authorized at 368, a payment authorization is re-submitted at 384 via the disbursement authorization API 115, to determine whether the borrower/lender or both need to be involved (as potential payees of the distribution) at 386. A response may be returned to the insurance carrier 360 to confirm and/or select the payee, and to communicate to the disbursement authorization API 115 at 388, information regarding payment confirmation.

According to certain embodiments, payment confirmation may be transmitted to the disbursement authorization apparatus 108 via a payment notification data object. Table 10 below provides an example schema by which the carrier system 120 and/or client device 122 notifies the disbursement authorization apparatus 108 of a payment.

TABLE 10

| | | Required/ | | | |
|---|---|---|---|---|---|
| | Field Name | Optional | Data Type | Field Description | Example |
| 1 | trackingNo | Required | Integer | Tracking/Claim | 5195781 |
| | | | | Number | |
| 2 | issueDate | Optional | String | Payment Issue Date | YYYY-MM-DD |
| 3 | checks | Required | Array[CheckDetail] | The amount of your | “checkNumber”: |
| | | | | check(s) | “IB123987”, |
| | | | | | “Amount”: 1250.00, |
| | | | | | “Payees”: “Mickey |
| | | | | | Mouse; Minnie |
| | | | | | Mouse” |
| 4 | checkNumber | Optional | CheckDetail | Check Number | LW2228585s |
| | | | {String} | | |
| 5 | Amount | Required | CheckDetail | Payment Amount | 1250.00 |
| | | | {Double} | [symbol] | |
| 6 | Payees | Optional | CheckDetail | Payee names | Bob Customer; |
| | | | {String} | separated by | Kamila Customer; |
| | | | | [symbol] | [symbol] |
| 7 | paymentInstructionID | Required | Integer | Payment Instruction | 5299 |
| | | | | ID | |
| 8 | isPublicAdjusterAssigned | Optional | Boolean | Is there a Public | true |
| | | | | Adjuster? | |
| 9 | carrierName | Required | String | Carrier Name/ | Your Carrier name |
| | | | | Source | |

[symbol]

indicates data missing or illegible when filed

Transmission of the payment notification data object assists the disbursement authorization data object processing system 108 and/or carrier system 120 in tracking and reconciling claims and payments. The disbursement authorization data object processing system 108 may update data associated with a tracked claim in repository 106 with the payment parameters from the payment notification data object.

A code segment corresponding to Table 10 is provided below.

{
“trackingNo”: 7286522,
“issueDate”: “2020-08-09T04:00:00.000Z”,
“checks”: [
{
“checkNumber”: “IB123987”,
“Amount”: 1250.00,
“Payees”: “Mickey Mouse; Minnie Mouse”
}
],
“paymentInstructionId”: 15013,
“isPublicAdjusterAssigned”: true,
“carrierName”: “ Your Carrier Name ”
}

In response to a payment notification data object, the disbursement authorization apparatus 108 may transmit a payment response data object, confirming the update and/or returning an error code. Table 11 below provides an example schema of the payment response data object.

TABLE 11

| | | | |
|---|---|---|---|
| | Data | Field | |
| Field Name | Type | Description | Example |

| | | | |
|---|---|---|---|
| 1 | success | Boolean | true |
| 2 | code | Integer | 200 |
| 3 | message | String | |

A corresponding code segment is provided below.

```
  {
  “success”: true,
  “code”: 200,
  “message”: “Payment notice set for trackingNo: 7286522 and PaymentInstructionId: 15013
for Carrier: Your Carrier Name”
  }
```

The codes utilized in row 2 of Table 11 may include any of the example codes in Table 12 below.

TABLE 12

| HTTP | API | | |
|---|---|---|---|
| Status | Response | | |
| Code | Code | Message | Success |
| 200 | 200 | Success | TRUE |
| | 3100 | Retriable Error or Temporary Error | FALSE |
| 400 | N/A | Bad Request | NA |
| 401 | N/A | Unauthorized | NA |
| 500 | N/A | Internal Server Error (includes all | NA |
| | | unhandled exception as well as other | |
| | | catched exceptions that are not | |
| | | handled) | |

In this regard, the carrier system 120 receives notification of whether the payment notification is received and correctly processed by the disbursement authorization apparatus 108.

Returning to FIG. 3D, a separate process may begin at operation 392 to determine if an adjuster's worksheet is needed. If so, upon uploading of the adjuster's worksheet at the insurance center 360, and following authentication, the adjuster's worksheet may be uploaded as additional documentation, at 390. A corresponding exemplary additional documentation data object is provided above in Table 7.

In the process depicted at the right of FIG. 3D, the insurance carrier 360 may initiate that a payment has been voided or cancelled at 394, and the disbursement authorization API 115 updates records, such as on repository 106, to indicate the disbursement has been voided. Table 13 below provides an exemplary void payment data object that may be transmitted to the disbursement authorization apparatus 108 according to example embodiments.

TABLE 13

| | | Required/ | | | |
|---|---|---|---|---|---|
| | Field Name | Optional | Data Type | Field Description | Example |
| 1 | trackingNo | Required | Integer | Tracking/Claim Number | 7286522 |
| 2 | paymentInstructionId | Required | Integer | Payment Instruction ID | 15013 |
| 3 | carrierName | Optional | String | Carrier Name/ Source | Your Carrier name |

The carrier system 120 may generate a cancel request passing the parameters as set forth above. A corresponding code segment is provided below.

{
“trackingNo”: 7286522,
“paymentInstructionId”: 15013,
“carrierName”: “Your Carrier Name”
}

In response, the disbursement authorization apparatus 108 updates the disbursement authorization parameters associated with the tracking number or other unique authentication key, in repository 106, to indicate the payment is voided or cancelled. The carrier system 120 and/or client device 122 can then resubmit a request with corrected data.

An example void payment response data object is provided below in Table 14.

TABLE 14

| | Field Name | Data Type | Description | Example |
|---|---|---|---|---|
| 1 | success | Boolean | success | True |
| 2 | code | Integer | code | 200 |
| 3 | message | String | message | |

A corresponding code segment is below.

```
{
  “success”: true,
  “code”: 200,
  “message”: “Payment Authorization : 15013 is voided”
}
```

Table 15 below provides example codes that may be passed in row 2 of Table 14 to indicate the status of the void payment data object.

TABLE 15

| HTTP | API | | |
|---|---|---|---|
| Status | Response | | |
| Code | Code | Message | Success |
| 200 | 200 | Success | TRUE |
| | 3001 | Duplicate Request | FALSE |
| | 3100 | Retriable Error or Temporary Error | FALSE |
| 400 | N/A | Bad Request | NA |
| 401 | N/A | Unauthorized | NA |
| 500 | N/A | Internal Server Error (includes all | NA |
| | | unhandled exception as well as other | |
| | | catched exceptions that are not | |
| | | handled) | |

The carrier system 120 may utilize the void payment data object to render a response via user device 110, such as confirming cancellation of the payment and/or notifying a user of an error.

According to certain embodiments, the disbursement authorization API 115 additionally provides the option for a carrier system 120 and/or client device 122 to check the availability and status of the disbursement authorization API 115. To invoke this functionality of the API 115, which may be also referred to as a metadata request, the carrier system 120 and/or client device 122 adds a predetermined suffix with a predetermined query parameter, such as “/Metadata?pingApim=true” to a predetermined implementation and/or test-environment uniform resource locator (URL). The carrier system 120 and/or client device 122 creates a Get request passing the query parameter as header parameters. The parameters can be processed by the disbursement authorization apparatus 108 to communicate different information and statuses accordingly. For example, if pingApim value is ‘true’ then the disbursement authorization apparatus 108 returns from the APIM Gateway/frontend API platform. As another example, if the pingApim flag is ‘false’ then the disbursement authorization apparatus 108 returns a cause of loss metadata. If the query parameter is not passed, then a default behavior may be to pass the metadata from the backend ensuring end to end all layers of the platform are working. A sample request includes: http://{{API URL}}/DTECDE/api/Metadata?pingApim=true.

A schema for an example metadata response data object when the pingApim query parameter is true, is provided below in Table 16.

TABLE 16

| | Field Name | Data Type | Example |
|---|---|---|---|
| 1 | success | Boolean | true |
| 2 | code | Integer | 1002 |
| 3 | message | String | API Metadata |

An example corresponding code segment is provided below.

```
{
“statusCode”: 200,
“errors”: “[ ]”,
“result”: {
  “success”: true,
  “code”: 200,
  “message”: “APIM Heartbeat”
}
}
```

A schema for an example metadata response data object when the pingApim query parameter is false, is provided below in Table 17.

TABLE 17

| | Field Name | Data Type | Description | Example |
|---|---|---|---|---|
| 1 | success | Boolean | | true |
| 2 | code | Integer | | 1002 |
| 3 | message | String | | Loan found |
| | | | | Payment |
| | | | | Instruction |
| | | | | generated. |
| 4 | causeOfLoss | Array | COL Endpoint | Hail |
| | | | list below | |
| 5 | notAllowedCauseOfLoss | Array | | |

A corresponding example code segment, including example cause of losses is provided below.

{
“version”: “1.0.0.1”,
“statusCode”: 200,
“errors”: [ ],
“result”: {
“causeOfLoss”: [
“ANIMAL INFESTATION”,
“ASBESTOS”,
“BIO HAZARD CLEAN UP”
“BOILER EXPLOSION”,
“CIVIL DISORDER”,
“EARTH MOVEMENT”,
“EARTHQUAKE”,
“EXPLOSION”,
“FALL STORM”,
“FIRE”,
“FLOOD”,
“FREEZE”,
“GROUND SATURATION”,
“HAIL”,
“HIGH SURF”,
“HURRICANE”,
“ICE”,
“ICE JAMS”,
“LANDSLIDE”,
“LEAD”,
“LIGHTNING”,
“MOLD”,
“MUD SLIDE”,
“OTHER”,
“POLLUTANT”,
“POWER OUTAGE”,
“RIOT”,
“SEWER BACK UP”,
“SINKHOLE”,
“SMOKE”,
“SNOW”,
“SNOW MELTS”,
“STORM”,
“THEFT”,
“THUNDERSTORM”,
“TIDAL SURGES”,
“TORNADOES”,
“TROPICAL STORM”,
“UNKNOWN”,
“VANDALISM”,
“VEHICLE COLLISION”,
“VOLCANIC ERUPTION”,
“WATER”,
“WILDFIRE”,
“WIND”,
“WINTER STORM”
],
“success”: true,
“code”: 200,
“message”: “API Metadata”
}
}

### Example Development and Testing Tool

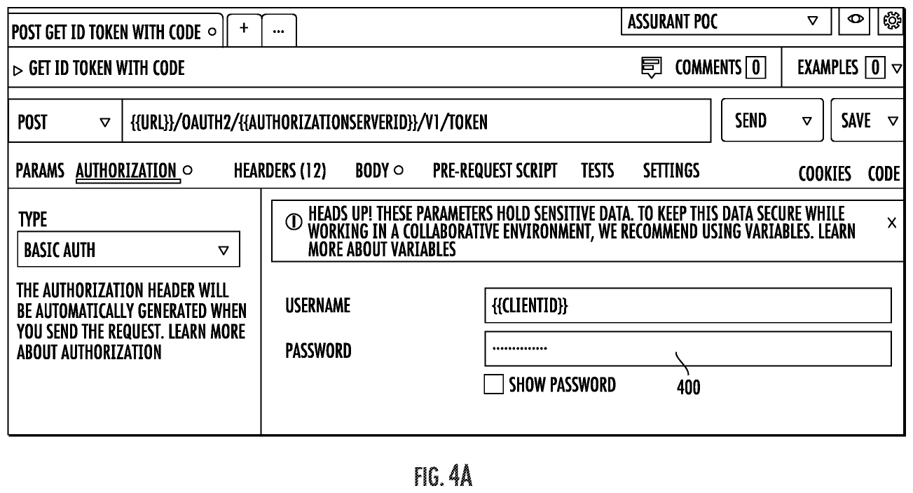

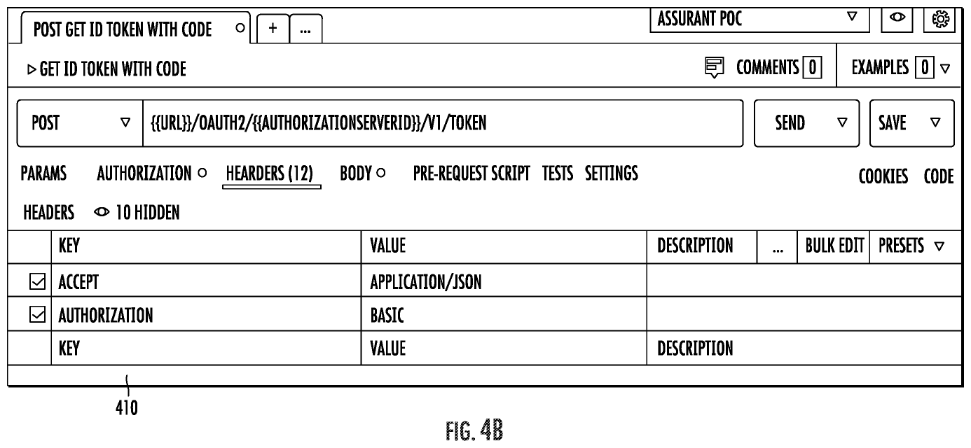

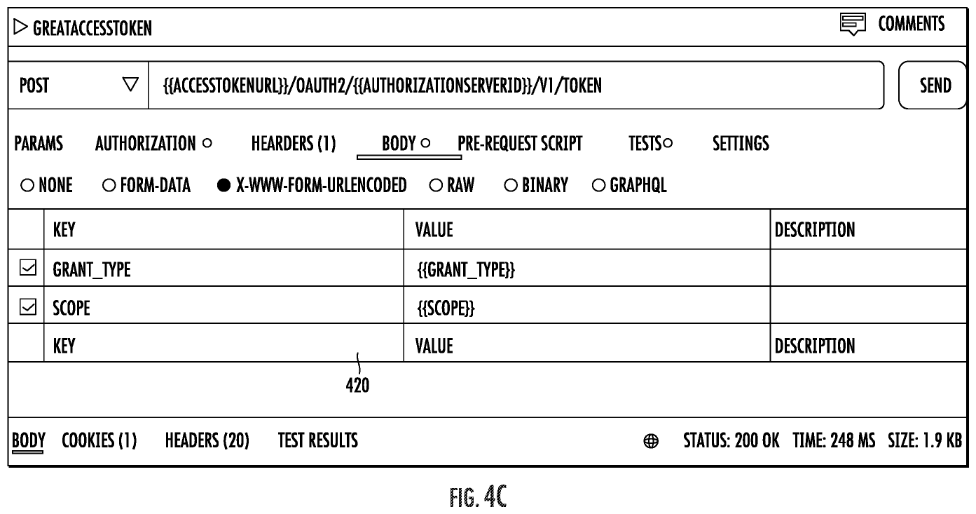

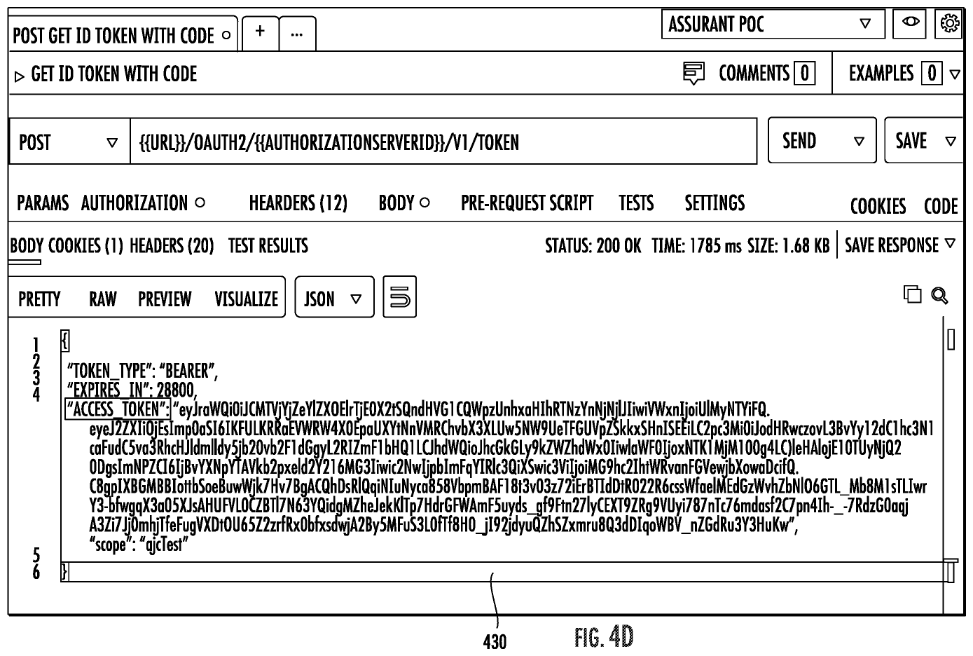

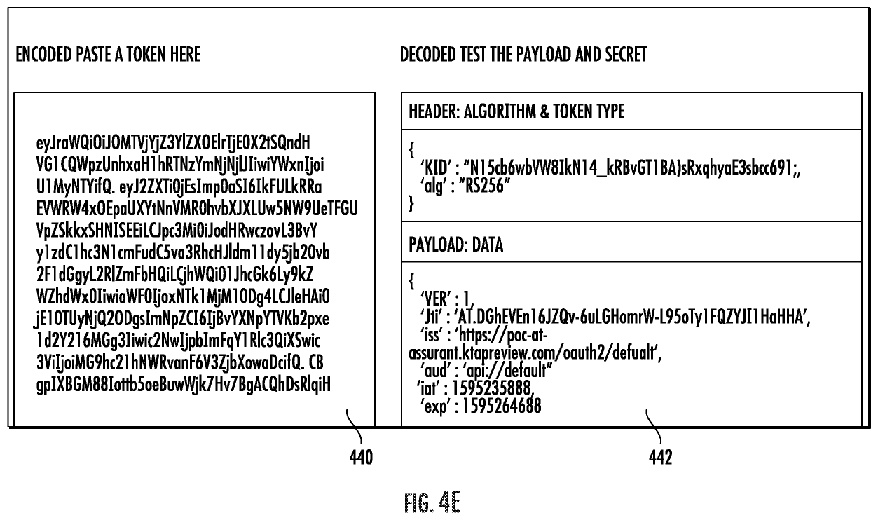

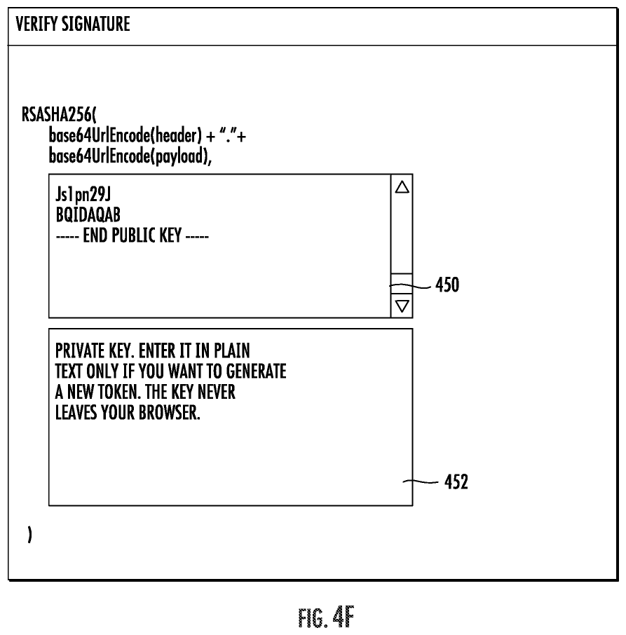

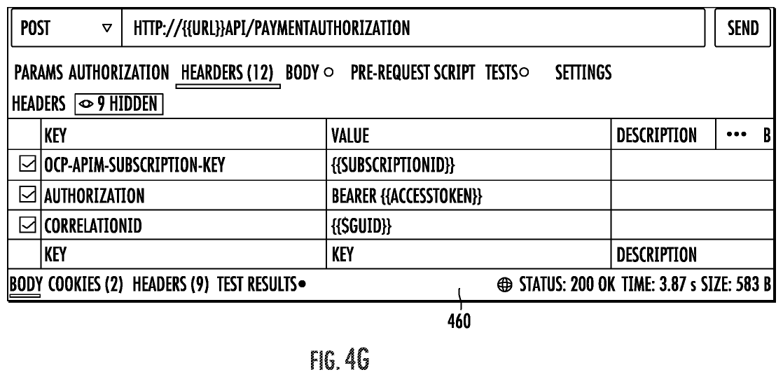

FIGS. 4A-4G are example user interfaces of a development and testing tool provided according to example embodiments. The distribution authorization apparatus 108 may provide the development and testing tool via a user interface 110 to assist developers of the carrier system 120 and/or client device 122 in developing or configuring the carrier system 120 and/or client device 122 to interface with the distribution authorization apparatus 108.

A user may access a URL to interact with the development and testing tool to obtain an access token and begin interacting with the distribution authorization API 115. As shown in the user interface of FIG. 4A, the distribution authorization apparatus 108 receives a username and password entered at 400 by a user. Using the user interface of FIG. 4B, the user makes selections 410 indicating what type of access token is requested. According to the example of FIG. 4B, the distribution authorization apparatus 108 receives a request for basic access.

As shown in FIG. 4C, the disbursement authorization apparatus 108 receives grant_type and scope, which may be entered by a user at 420. The authorization apparatus 108 may then return an access token, such as access token 430 of FIG. 4D.

The example user interface display of FIG. 4E enables a user to paste the access token in 440, and edit the payload and secret in 442. The example user interface display of FIG. 4F enables a user to access the public key 450 and/or enter a private key 452 to generate a new token. The example user interface display of FIG. 4G provides headers 460 of a request configured for the disbursement authorization API 115.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A disbursement authorization data object processing system configured to process disbursement authorization data objects received from a plurality of client devices in a network, the disbursement authorization data object processing system comprising one or more computers and one or more storage devices storing instructions that are operable, when executed by the one or more computers, to cause the disbursement authorization data object processing system to:
monitor the network to identify a received disbursement authorization data object;
parse the disbursement authorization data object to obtain disbursement authorization parameters and associate the disbursement authorization parameters with at least a first recipient entity and at least one external entity based on the disbursement authorization parameters;
in response to parsing the disbursement authorization data object, invoke a real-time status reporting service to retrieve at least one real-time status report data object associated with the disbursement authorization parameters and comprising real-time status report data;
in response to retrieving the real-time status report data object, using at least the real-time status report data object and the disbursement authorization parameters, invoke a disbursement authorization service of the disbursement authorization data object processing system to determine recipient instruction data;
generate a disbursement instruction data object comprising at least the recipient instruction data; and
cause transmission of the disbursement instruction data object to a client device from which the disbursement authorization data object was received.

2. The disbursement authorization data object processing system of claim 1, wherein determining the recipient instruction data comprises determining whether two or more external entities are identified as potential additional recipient entities, wherein the instructions are further operable to cause the disbursement authorization data object processing system to:
generate a unique authentication key;
store the unique authentication key in association with the disbursement authorization parameters; and
populate the disbursement instruction data object with the unique authentication key prior to the transmission of the disbursement authorization data object to the client device from which the disbursement authorization data object was received.

3. The disbursement authorization data object processing system of claim 2, wherein the instructions are further operable to cause the disbursement authorization data object processing system to:
receive a resubmission disbursement authorization data object comprising at least the unique authentication key and a selected one of the two or more external entities identified as potential additional recipient entities; and
populate the disbursement authorization parameters associated with the unique authentication key with the selected one of the two or more external entities identifies as potential additional recipient entities, wherein invoking the disbursement authorization service comprises utilizing the disbursement authorization parameters populated with the selected one of the two or more external entities.

4. The disbursement authorization data object processing system of claim 1, wherein the instructions are further operable to cause the disbursement authorization data object processing system to:
determine whether additional documentation is required; and
populate the disbursement instruction data object with an additional documentation required indicator prior to the transmission of the disbursement instruction data object to the client device from which the disbursement authorization data object was received.

5. The disbursement authorization data object processing system of claim 4, wherein the disbursement instruction data object comprises a unique authentication key, and wherein the instructions are further operable to cause the disbursement authorization data object processing system to:
receive an additional documentation data object comprising at least the unique authentication key and a document; and
parse the document and update at least one of the disbursement authorization parameters associated with the authentication key with adjustment data parsed from the document, wherein invoking the disbursement authorization service comprises utilizing the updated disbursement authorization parameters comprising the adjustment data.

6. The disbursement authorization data object processing system of claim 1, wherein the disbursement authorization parameters comprise at least two entities, and wherein invoking the disbursement authorization service comprises determining at least one of the two entities is not required as an additional recipient entity of an associated disbursement.

7. The disbursement authorization data object processing system of claim 1, wherein invoking the disbursement authorization service comprises utilizing the disbursement authorization parameters and the real-time status report data to process at least one external entity rule set associated with the disbursement authorization parameters.

8. The disbursement authorization data object processing system of claim 7, wherein if any rules indicate at least one external entity is required, populate the disbursement instruction data object with an indication that the external entity is required as an additional recipient entity.

9. The disbursement authorization data object processing system of claim 1, wherein the real-time status report data object comprises a delinquency indicator, and wherein invoking the disbursement authorization service results in the recipient instruction data indicating the at least one external entity is required as an additional recipient entity.

10. A computer-implemented method for processing disbursement authorization data objects received from a plurality of client devices in a network, the computer-implemented method comprising:
monitoring the network to identify a received disbursement authorization data object;
parsing the disbursement authorization data object to obtain disbursement authorization parameters and associate the disbursement authorization parameters with at least a first recipient entity and at least one external entity based on the disbursement authorization parameters;
in response to parsing the disbursement authorization data object, invoking a real-time status reporting service to retrieve at least one real-time status report data object associated with the disbursement authorization parameters and comprising real-time status report data;
in response to retrieving the real-time status report data object, using at least the real-time status report data object and the disbursement authorization parameters, invoking a disbursement authorization service of the disbursement authorization data object processing system to determine recipient instruction data;
generating a disbursement instruction data object comprising at least the recipient instruction data; and
causing transmission of the disbursement instruction data object to a client device from which the disbursement authorization data object was received.

11. The computer-implemented method of claim 10, wherein determining the recipient instruction data comprises determining whether two or more external entities are identified as potential additional recipient entities, and wherein the computer-implemented method further comprises:
generating a unique authentication key;
storing the unique authentication key in association with the disbursement authorization parameters; and
populating the disbursement instruction data object with the unique authentication key prior to the transmission of the disbursement authorization data object to the client device from which the disbursement authorization data object was received.

12. The computer-implemented method of claim 11, wherein the computer-implemented method further comprises:
receiving a resubmission disbursement authorization data object comprising at least the unique authentication key and a selected one of the two or more external entities identified as potential additional recipient entities; and
populating the disbursement authorization parameters associated with the unique authentication key with the selected one of the two or more external entities identifies as potential additional recipient entities, wherein invoking the disbursement authorization service comprises utilizing the disbursement authorization parameters populated with the selected one of the two or more external entities.

13. The computer-implemented method of claim 10, wherein the computer-implemented method further comprises:
determining whether additional documentation is required; and
populating the disbursement instruction data object with an additional documentation required indicator prior to the transmission of the disbursement instruction data object to the client device from which the disbursement authorization data object was received.

14. The computer-implemented method of claim 13, wherein the computer-implemented method further comprises:
receiving an additional documentation data object comprising at least the unique authentication key and a document; and
parsing the document and update at least one of the disbursement authorization parameters associated with the authentication key with adjustment data parsed from the document, wherein invoking the disbursement authorization service comprises utilizing the updated disbursement authorization parameters comprising the adjustment data.

15. The computer-implemented method of claim 10, wherein the disbursement authorization parameters comprise at least two entities, and wherein invoking the disbursement authorization service comprises determining at least one of the two entities is not required as an additional recipient entity of an associated disbursement.

16. The computer-implemented method of claim 10, wherein invoking the disbursement authorization service comprises utilizing the disbursement authorization parameters and the real-time status report data to process at least one external entity rule set associated with the disbursement authorization parameters.

17. The computer-implemented method of claim 16, wherein if any rules indicate at least one external entity is required, populate the disbursement instruction data object with an indication that the external entity is required as an additional recipient entity.

18. The computer-implemented method of claim 10, wherein the real-time status report data object comprises a delinquency indicator, and wherein invoking the disbursement authorization service results in the recipient instruction data indicating the at least one external entity is required as an additional recipient entity.

19. A computer program product for processing disbursement authorization data objects received from a plurality of client devices in a network, the computer program product comprising at least one non-transitory computer-readable storage medium having computer-executable program code instructions stored therein, the computer-executable program code instructions comprising program code instructions to:
monitor the network to identify a received disbursement authorization data object;
parse the disbursement authorization data object to obtain disbursement authorization parameters and associate the disbursement authorization parameters with at least a first recipient entity and at least one external entity based on the disbursement authorization parameters;
in response to parsing the disbursement authorization data object, invoke a real-time status reporting service to retrieve at least one real-time status report data object associated with the disbursement authorization parameters and comprising real-time status report data;
in response to retrieving the real-time status report data object, using at least the real-time status report data object and the disbursement authorization parameters, invoke a disbursement authorization service of the disbursement authorization data object processing system to determine recipient instruction data;
generate a disbursement instruction data object comprising at least the recipient instruction data; and
cause transmission of the disbursement instruction data object to a client device from which the disbursement authorization data object was received.

20. The computer program product according to claim 19, wherein the computer-executable program code instructions further comprise program code instructions to:
generate a unique authentication key;
store the unique authentication key in association with the disbursement authorization parameters; and
populate the disbursement instruction data object with the unique authentication key prior to the transmission of the disbursement authorization data object to the client device from which the disbursement authorization data object was received.
